(19) United States
(12) Patent Application Publication
(10) Pub. No.: US 2026/0186279 A1
(43) Pub. Date: Jul. 2, 2026

(54) OPTICAL SYSTEM AND CAMERA MODULE

(71) Applicant: LG INNOTEK CO., LTD., Seoul (KR)

(72) Inventor: Doo Shik SIN, Seoul (KR)

(21) Appl. No.: 19/129,889

(22) PCT Filed: Nov. 16, 2023
(86) PCT No.: PCT/KR2023/018427

§ 371 Date: May 14, 2025

(30) Foreign Application Priority Data
Nov. 16, 2022 (KR) 10-2022-0153752
Nov. 16, 2022 (KR) 10-2022-0153763

(51) Int. Cl. G02B 15/14; G02B 15/177

(52) U.S. Cl. CPC G02B 15/143503; G02B 15/177

(57) ABSTRACT

The optical system disclosed in the embodiment of the invention includes first to third lens groups arranged along an optical axis from an object side toward a sensor side, wherein the first lens group and the third lens group have negative power, the second lens group has positive power, a position of the first lens group is fixed, the second and third lens groups are movable in the optical axis direction, the optical system having the first to third lens groups has operation modes having different magnifications according to the movement of at least one of the second and third lens groups, at least one of the second and third lens groups has a lens having the thickest center thickness among the lenses, the optical axis distance between a surface of the lenses of the first lens group closest to the object and an imaging surface of an image sensor is TTL, and a size of the entrance pupil diameter of the optical system at the highest magnification in the operation mode is EPD3, and the following Equation may satisfy: 2<TTL/EPD3<7.

### TECHNICAL FIELD

An embodiment of the invention relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted. When the optical system includes a plurality of lenses, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses.

The size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system.

When the optical system includes a plurality of lenses, the position of at least one lens or a lens group including at least one lens may be controlled to perform functions such as zoom and autofocus (AF). However, when the lens or the lens group performs the function, the amount of movement of the lens or the lens group can increase exponentially. Accordingly, the optical system has a problem in that a lot of energy may be required for the movement of the lens or the lens group, and a large volume is required in consideration of the amount of movement. In addition, there is a problem in that aberration characteristics deteriorate due to the movement of the lens or the lens group. Accordingly, there is a problem in that optical characteristics deteriorate at a specific magnification when performing the zoom and autofocus (AF) functions. Therefore, a new optical system capable of solving the above-described problems is required.

### DISCLOSURE

### Technical Problem

An embodiment of the invention provides an optical system having improved optical characteristics. An embodiment provides an optical system and a camera module capable of photographing at various magnifications. An embodiment provides an optical system and a camera module having improved aberration characteristics at various magnifications. An embodiment provides an optical system and a camera module that may be implemented in a small and compact manner.

### Technical Solution

An optical system according to an embodiment of the invention includes first to third lens groups arranged along an optical axis direction from an object side to a sensor side an including each of which includes at least one lens, wherein the first lens group and the third lens group have negative power, the second lens group has positive power, a position of the first lens group is fixed, the second lens group has a smaller number of lenses than a number of lenses of the first lens group, the second and third lens groups are movable in the optical axis direction, and the optical system having the first to third lens groups has operation modes of different magnifications according to a movement of at least one of the second lens group and the third lens group, and at least one of the second and third lens groups has a lens having the thickest center thickness among the lenses, and the optical axis distance between a surface of the first lens group closest to the object side and an imaging surface of an image sensor is TTL, and a size of the entrance pupil diameter of the optical system at the highest magnification in the operation mode is EPD3, and the following Equation may satisfy: 2<TTL/EPD3<7.

According to an embodiment of the invention, an optical axis distance between a lens closest to the image sensor and the image sensor in the third lens group may vary depending on the operation mode, and the optical axis distance between the object-side surface of the lens closest to the object in the first lens group and the sensor-side surface of the lens closest to the image sensor in the third lens group may vary depending on the operation mode.

According to an embodiment of the invention, the operation mode includes a wide mode, the wide mode is Model, and in the wide mode, the optical axis distance between the first and second lens groups is DG12, and the optical axis distance between the second and third lens groups is DG23, and the following Equation may satisfy: 1<Model (DG12/DG23)<5.

According to an embodiment of the invention, the operation mode includes a tele mode, the tele mode is Mode3, and in the tele mode, the optical axis distance between the first and second lens groups is DG12, and the optical axis distance between the second and third lens groups is DG23, and the following Equation may satisfy: 0<Mode3 (DG12/DG23)<0.7.

According to an embodiment of the invention, the maximum distance between adjacent lenses according to the operation mode is Mode_CG_Max, and the minimum distance between adjacent lenses according to the operation mode is Mode_CG_Min, and the following Equation may satisfy: 2<Mode_CG_Max/Mode_CG_Min<8.

According to an embodiment of the invention, the number of lenses of the first lens group is 3, the number of lenses of the third lens group is 2 or 3, and the absolute value of the focal length of the first and third lens groups may be greater than the focal length of the second lens group.

According to an embodiment of the invention, the optical system includes a wide mode having a first effective focal length (EFL1), a middle mode having a second effective focal length (EFL2), and a tele mode having a third effective focal length (EFL3), and may satisfy the Equation: EFL1<ELF2<EFL3.

According to an embodiment of the invention, a field of view in the wide mode is FOV1, the field of view in the middle mode is FOV2, and a field of view in the tele mode is FOV3, and may satisfy the Equation: 8 degrees<FOV3<FOV2<FOV1<45 degrees.

According to an embodiment of the invention, the second lens group may include an object-side lens having an aspherical surface made of glass and having a convex shape on both sides, and a sensor-side lens having an aspherical surface made of plastic on the sensor side of the object-side lens.

An optical system according to an embodiment of the invention includes a first lens group having first to third lenses; a second lens group having fourth and fifth lenses; a third lens group having at least two lenses, wherein the first lens group, the second lens group, and the third lens group are arranged in the optical axis direction from the object side to the sensor side, the first lens has positive refractive power and has a convex shape on the object side, the third lens has negative refractive power and has a concave shape on both sides, the fourth lens has positive refractive power and has a convex shape on both sides, the last lens of the third lens group closest to the image sensor has negative refractive power, the second lens group and the third lens group move in the optical axis direction, and the optical axis distance between the last lens and the image sensor may be varied depending on the operation mode.

According to an embodiment of the invention, the first lens group may have negative (−) refractive power, the first lens may have a meniscus shape convex toward the object side, the second lens may have a meniscus shape convex toward the sensor side, and the second and fifth lenses may have negative refractive power.

According to an embodiment of the invention, the fourth lens and the last lens may have refractive indices of less than 1.6, the fourth lens may be made of glass, and the lenses other than the fourth lens may be made of plastic.

According to an embodiment of the invention, the first lens may have different maximum lengths in the first direction perpendicular to the optical axis and maximum lengths in the second direction, and the maximum lengths of the first lens in the first and second directions may be the largest among the lenses, and a difference between the center thickness and the edge thickness of the fifth lens may be 0.9 or more, and a difference between the center thickness and the edge thickness of the sixth lens may be 0.9 or more.

According to an embodiment of the invention, the optical axis distance between the first and second lens groups and the optical axis distance between the second and third lens groups are at least 0.2 mm or more and at most 8 mm or less, the optical axis distance from the center of the object-side surface of the fourth lens to the center of the sensor-side surface of the fifth lens is DG2, and the optical axis distance from the object-side surface of the first lens to the imaging surface of the image sensor is TTL, and may satisfy the Equation: 3<TTL/DG2<10.

A camera module according to an embodiment of the invention is a camera module including an optical system and a driving member, wherein the optical system includes the optical system disclosed above, and the driving member may move at least one of the second and third lens groups in the optical axis direction according to the operation mode of the optical system.

### Advantageous Effects

An optical system and camera module according to the embodiment have various magnifications and may have excellent optical characteristics when providing various magnifications. In detail, the embodiment can control the movement distance of each of the moving lens groups to have various magnifications and provide an autofocus (AF) function for the subject. The optical system and camera module according to the embodiment can compensate for aberration characteristics of multiple lens groups or mutually complement aberration characteristics that change due to movement. Accordingly, the optical system according to the embodiment can minimize or prevent changes in chromatic aberration and aberration characteristics that occur when the magnification changes.

The optical system and camera module according to the embodiment can control the effective focal length (EFL) by moving only some of the multiple lens groups and can minimize the movement distance of the moving lens group. Accordingly, the optical system can reduce the movement distance of the moving lens group according to the change in the operation mode and minimize the power consumption required when the lens group moves. The optical system may have at least one lens included in the fixed group and the moving group have a non-circular shape. Accordingly, the optical system can reduce the height of the optical system while maintaining the optical performance, and secure a space in which the lens groups arranged between the plurality of lens groups are structurally arranged.

The optical system and the camera module according to the embodiment can adjust the magnification to enlarge or reduce the object by moving a lens group other than the first lens group adjacent to the subject among the plurality of lens groups. Accordingly, the optical system may have a constant TTL value even when the lens group is moved according to the magnification change so as to have multiple focal lengths, and may be applied to a camera module for linear zoom. Therefore, the optical system and the camera module including the same may be provided with a slimmer structure.

### DESCRIPTION OF DRAWINGS

FIG. 1 is a configuration diagram of an optical system and a camera module having the same according to the first embodiment.

FIG. 2 is an example of changing the first mode of the optical system of FIG. 1.

FIG. 3 is an example of changing the third mode in the optical system of FIG. 1 and FIG. 2.

FIG. 4 is a table of lens data of the optical system according to the first embodiment.

FIG. 5 is a graph showing relative illumination according to the positions of wide, middle, and tele modes according to the first embodiment.

FIG. 6 is a graph of diffraction MTF in the optical system of the first mode (Wide Mode) according to the first embodiment.

FIG. 7 is a graph of diffraction MTF in the optical system of the second mode (Middle Mode) according to the first embodiment.

FIG. 8 is a graph of diffraction MTF in the optical system of the third mode (Tele Mode) according to the first embodiment.

FIG. 9 is a graph showing aberration characteristics in the optical system of the first mode according to the first embodiment.

FIG. 10 is a graph showing aberration characteristics in the optical system of the second mode according to the first embodiment.

FIG. 11 is a graph showing aberration characteristics in the optical system of the third mode according to the first embodiment.

FIG. 12 is a configuration diagram of an optical system and a camera module having the same according to the second embodiment.

FIG. 13 is an example of a change in the first mode of the optical system of FIG. 12.

FIG. 14 is an example of a change in the third mode in the optical systems of FIGS. 12 and 13.

FIG. 23 is a configuration having a reflective mirror in the optical system of FIG. 12.

FIG. 15 is a table of lens data of the optical system according to the second embodiment.

FIG. 16 is a graph showing relative illuminance according to the positions of wide, middle, and tele modes according to the second embodiment.

FIG. 17 is a graph showing diffraction MTF in the optical system of the first mode (Wide Mode) according to the second embodiment.

FIG. 18 is a graph showing diffraction MTF in the optical system of the second mode (Middle Mode) according to the second embodiment.

FIG. 19 is a graph showing diffraction MTF in the optical system of the third mode (Tele Mode) according to the second embodiment.

FIG. 20 is a graph showing aberration characteristics in the optical system of the first mode according to the second embodiment.

FIG. 21 is a graph showing aberration characteristics in the optical system of the second mode according to the second embodiment.

FIG. 22 is a graph showing aberration characteristics in the optical system of the third mode according to the second embodiment.

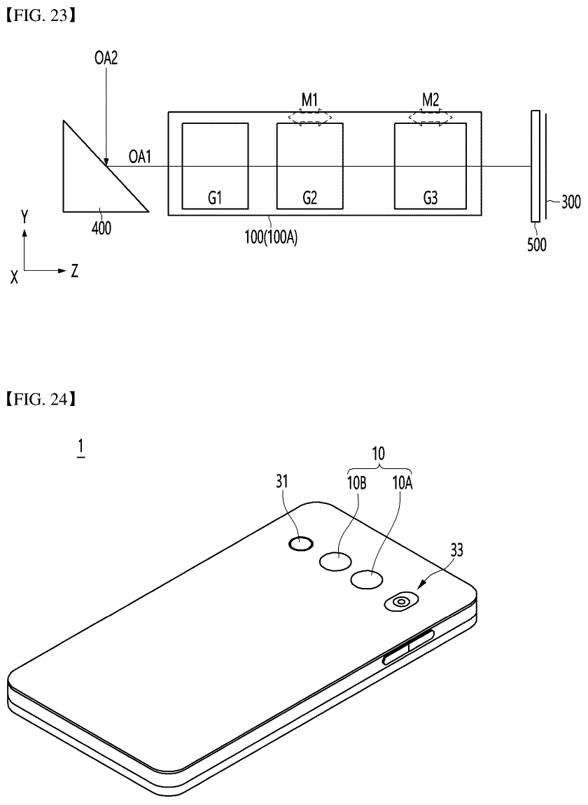

FIG. 23 is a configuration of an optical system having a reflective mirror according to the first and second embodiments.

FIG. 24 is a drawing showing a camera module according to the first and second embodiments of the invention applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, a convex surface of the lens may mean that the lens surface in a region corresponding to the optical axis has a convex shape based on the optical axis, and a concave surface of the lens may mean that the lens surface in a region corresponding to the optical axis has a concave shape. In addition, the “object-side surface” may mean a surface of the lens facing the object side based on the optical axis, and the “sensor-side surface” may mean a surface of the lens facing the imaging surface (image sensor) based on the optical axis. In addition, a center thickness of the lens may mean the thickness of the lens in the optical axis direction. In addition, a vertical direction may mean a direction perpendicular to the optical axis, and the end of the lens or lens surface may mean the end of the effective region of the lens through which incident light passes. In addition, the size of the effective diameter of the lens surface may have a measurement error of up to ±0.4 mm depending on the measurement method, etc.

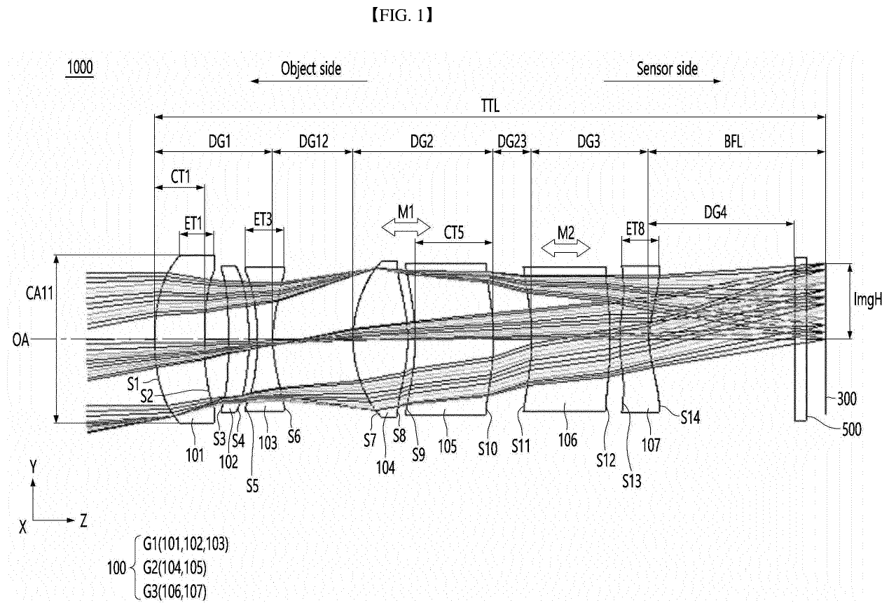

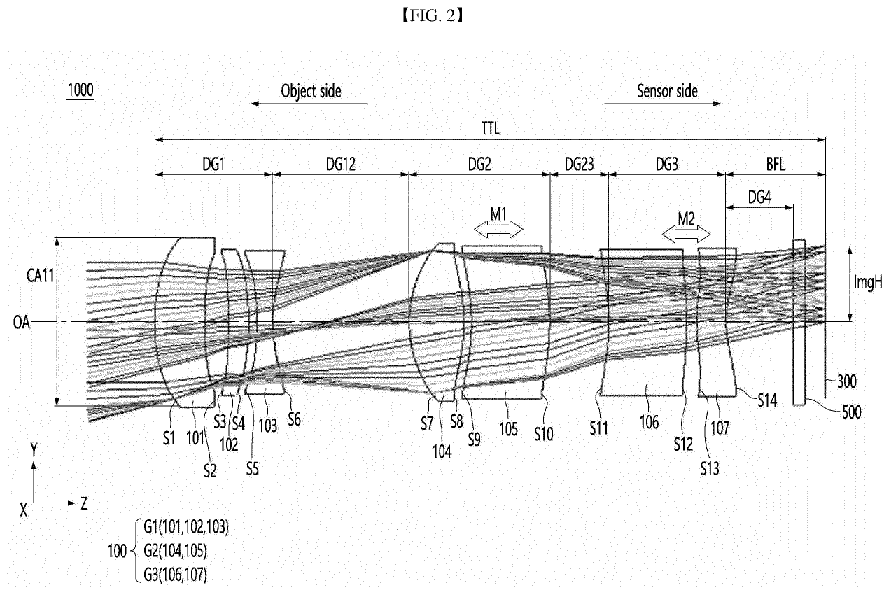

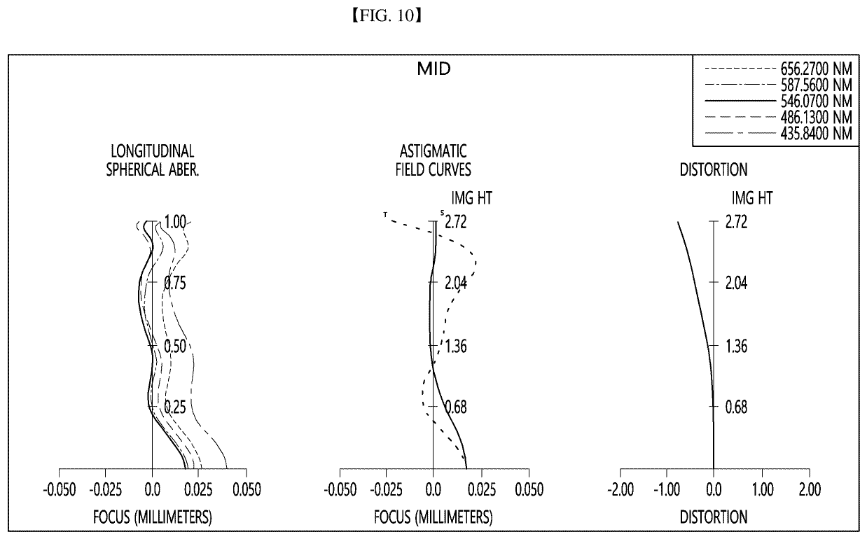

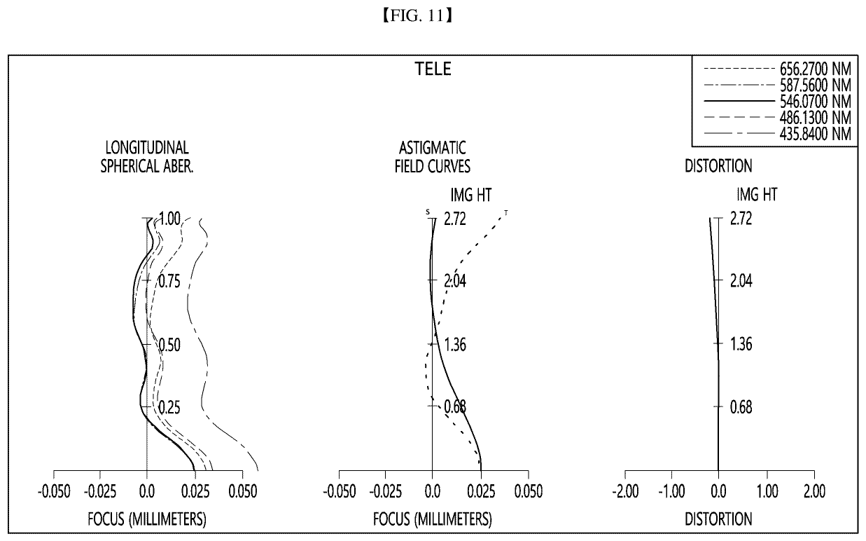

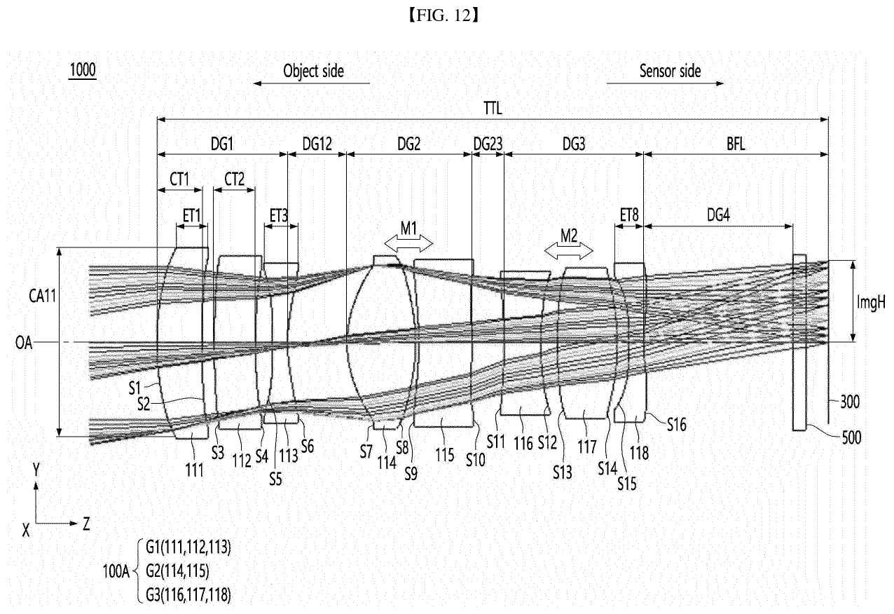

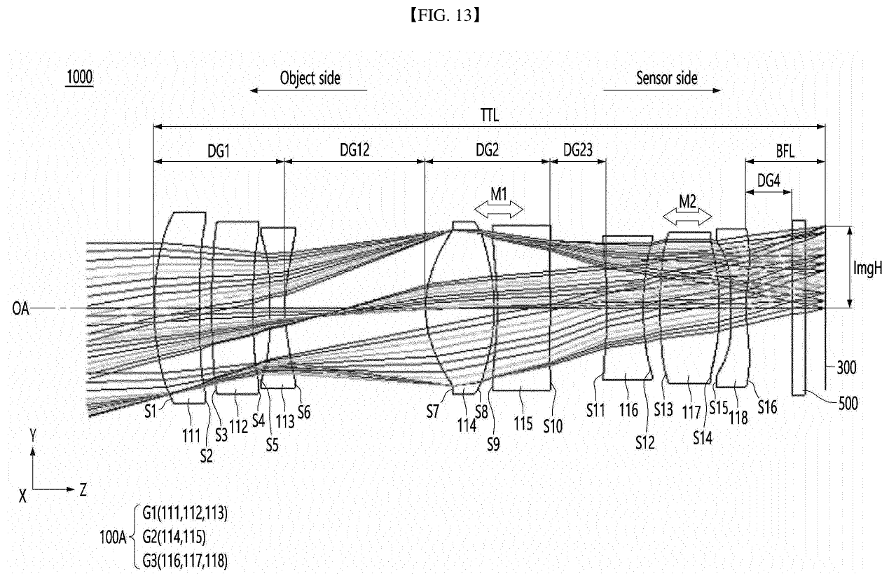

FIGS. 1 to 11 are drawings explaining an optical system according to a first embodiment of the invention.

Referring to FIGS. 1 to 11, an optical system 1000 according to the first embodiment may include a plurality of lens groups G1, G2 and G3. The plurality of lens groups G1, G2 and G3 may have at least two lens groups that are movable in the direction of the optical axis OA and at least one lens group that is fixed in position. The plurality of lens groups G1, G2 and G3 may include a fixed lens group located on the object side and a moving lens group located on the sensor side. Here, the object side is a region adjacent to the object within the optical system 1000, and the sensor side is a region adjacent to the image sensor 300 within the optical system 1000.

The moving lens groups may include an object-side lens group and a sensor-side lens group. The fixed lens group may be defined as a first lens group G1, the object-side moving lens group may be defined as a second lens group G2, and the sensor-side moving lens group may be defined as a third lens group G3. The second lens group G2 may be arranged between the first lens group G1 and the third lens group G3. The first lens group G1 collects incident light, the second lens group G2 changes a zoom ratio (focal length), and the third lens group G3 may adjust a focal position on an image plane of the image sensor 300.

The number of lenses of the first lens group G1 may be greater than the number of lenses of the second lens group G2. The number of lenses of the third lens group G3 may be less than the number of lenses of the first lens group G1. The number of lenses of the first lens group G1 may include at least three lenses for adjusting the incident light amount, refractive power, and chromatic aberration. The second and third lens groups G2 and G3 may include at least two lenses. For example, the optical system may further include at least one lens fixed between the third lens group G3 and the image sensor 300.

The first to third lens groups G1, G2 and G3 may be sequentially arranged along the optical axis OA from the object side toward the sensor. The optical system 1000 may include an image sensor 300 arranged on the sensor side of the third lens group G3. The optical system 1000 may include an optical filter 500 arranged on the object side of the image sensor 300.

Each of the first to third lens groups G1, G2 and G3 may have positive (+) or negative (−) refractive power. In the optical system 1000, lens groups having positive refractive power may be at least two lens groups, and lens groups having negative refractive power may be a single lens group. The first lens group G1 may have refractive power opposite to that of the second lens group G2. For example, the first lens group G1 may have negative (−) refractive power, and the second lens group G2 may have positive (+) refractive power. The second lens group G2 may have refractive power opposite to that of the third lens group G3. For example, the second lens group G2 may have positive (+) refractive power, and the third lens group G3 may have negative (−) refractive power. The third lens group G3 may have negative (−) refractive power. The absolute value of the power of the first lens group G1 may be greater than the absolute value of the power of the second and third lens groups G2 and G3. For example, the absolute value of the power of the first lens group G1 may be at least twice the absolute value of the power of the second lens group G2. Accordingly, the first lens group G1 may disperse the incident light. The first and third lens groups (G1, G3) may have negative power, and the second lens group G2 may have positive power.

The focal length of the second lens group G2 may have a sign opposite to the focal length of the first lens group G1. The focal length of the second lens group G2 may have a positive (+) sign, and the focal length of the first lens group G1 may have a negative (−) sign. The refractive power is the reciprocal of the focal length. As described above, since the second and third lens groups G2 and G3 have opposite refractive powers, the focal length of the second lens group G2 may have a sign (+, −) opposite to the focal length of the third lens group G3. For example, the focal length of the second lens group G2 may have a positive (+) sign, and the focal length of the third lens group G3 may have a negative (−) sign.

The absolute values of the focal lengths of each of the first to third lens groups G1, G2 and G3 may decrease in the order of the first lens group G1, the third lens group G3, and the second lens group G2. The first lens group G1 is fixed in position, and the second lens group G2 and the third lens group G3 move in the direction of the optical axis OA. Accordingly, the optical system 1000 may provide various magnifications by moving the second and third lens groups G2 and G3. Hereinafter, the first to third lens groups G1, G2 and G3 will be described in more detail. The first lens group G1 may have at least two lenses with opposite refractive powers. For example, the first lens group G1 may include three lenses. The first lens group G1 may have more lenses with positive refractive powers than lenses with negative refractive powers.

The plurality of lenses included in the first lens group G1 may have a set interval. In detail, the center distance between the plurality of lenses included in the first lens group G1 may be a fixed interval according to the operation mode described below. For example, the center distance (CG1) between the first lens 101 and the second lens 102, and the center distance (CG2) between the second lens 102 and the third lens 103 may not change depending on the operation mode and may have a constant distance. Here, the center distance (CG) between the lenses may mean the optical axis distance between adjacent lenses.

The second lens group G2 may include a plurality of lenses. In detail, the second lens group G2 may include three or fewer lenses having refractive power. The number of lenses included in the second lens group G2 may be one or more less than the number of lenses included in the first lens group G1. For example, the second lens group G2 may include two lenses having the same refractive power. The plurality of lenses included in the second lens group G2 may have a set distance. In detail, the center distance (CG) between the plurality of lenses included in the second lens group G2 may be a fixed distance according to the operation mode described below. For example, the center distance CG4 between the fourth lens 104 and the fifth lens 105 may not change depending on the operation mode and may have a constant distance.

The third lens group G3 may include a plurality of lenses. In detail, the third lens group G3 may include two or more lenses having refractive power. The lenses included in the third lens group G3 may have negative refractive power. The number of lenses included in the third lens group G3 may be the same as the number of lenses included in the second lens group G2. For example, the third lens group G3 may include two lenses. The plurality of lenses included in the third lens group G3 may have a set distance. In detail, the center distance between the plurality of lenses included in the third lens group G3 may be constant without changing even when the operation mode described later changes. For example, the center distance CG6 between the sixth lens 106 and the seventh lens 107 may be constant without changing depending on the operation mode. The distance DG4 between the last lens included in the third lens group G3 and the optical filter 500 may vary depending on the operation mode. In addition, the distance between the last lens and the image sensor 300 is BFL and may vary depending on the operation mode.

The lens unit 100 includes a plurality of lens groups G1, G2 and G3. The lens unit 100 may include first to seventh lenses 101-107. The first lens group G1 may include the first to third lenses 101, 102, and 103, and the second lens group G2 may include the fourth and fifth lenses 104 and 105. In addition, the third lens group G3 may include the sixth to seventh lenses 106 and 107. The first to seventh lenses 101-107 and the image sensor 300 may be sequentially arranged along the optical axis OA of the optical system 1000.

At least one of the lenses 101-103 of the first lens group G1 may have different lengths in the first direction Y orthogonal to the optical axis and in the second direction X. At least one of the lenses 101-103 of the first lens group G1 may include a non-circular lens. At least one of the lenses 104 and 105 of the second lens group G2 may have different lengths in the first direction Y orthogonal to the optical axis and in the second direction X, and may include, for example, a non-circular lens. At least one of the lenses 105-107 of the third lens group G3 may have different lengths in the first direction Y orthogonal to the optical axis and in the second direction X, and may include, for example, a non-circular lens. For example, the first lens 101 having the largest effective length among the effective lengths of the lenses may have different lengths in the first direction Y and in the second direction X. In addition, the fourth lens 104 having a large effective length among the lenses 104 and 105 of the second lens group G2 may have different lengths in the first direction Y and in the second direction X. The optical system 1000 according to the first embodiment may have improved assemblability by non-circular lens(es) and may have a mechanically stable form. In addition, the optical system 1000 may significantly reduce the moving distance of the moving lens group and provide various magnifications.

Each of the lenses may include an effective region and an ineffective region. The effective region is a region having an effective length and may be a region through which light incident on each of the first to seventh lenses 101-107 passes. The effective region may be a region in which the incident light is refracted to implement optical characteristics. The above-mentioned ineffective region may be arranged around the effective region. The above-mentioned ineffective region may be a region where the light is not incident. In other words, the above-mentioned ineffective region may be a region unrelated to the optical characteristics. In addition, the above-mentioned ineffective region may be an area fixed to a barrel (not shown) that accommodates the lens.

The image sensor 300 may detect light. The image sensor 300 may detect light that has sequentially passed through the lens unit 100, for example, the first to seventh lenses 101-107. The image sensor 300 may include a CCD (Charge coupled device) or a CMOS (Complementary metal oxide semiconductor). The optical filter 500 may be arranged between the lens unit 100 and the image sensor 300. The optical filter 500 may be placed between the image sensor 300 and the fourth lens group G4. For example, the optical filter 500 may be placed between the seventh lens 107 of the fourth lens group G4 and the image sensor 300.

The optical filter 500 may include at least one of an infrared filter and a cover glass. The optical filter 500 may pass light of a set wavelength band and filter light of a different wavelength band. When the optical filter 500 includes an infrared filter, it may block radiant heat emitted from external light from being transmitted to the image sensor 300. The optical filter 500 may transmit visible light and reflect infrared light.

The optical system 1000 may include an aperture stop (not shown). The aperture stop may adjust the amount of light incident on the optical system 1000. The aperture stop may be located on the periphery of the object-side surface of the first lens 101, or may be arranged between two lenses selected from the first to seventh lenses 101-107. For example, the aperture stop may be arranged on the periphery between the third lens 103 and the fourth lens 104. The aperture stop may be arranged on the periphery of the sensor-side surface of the third lens 103 or the periphery of the object-side surface of the fourth lens 104. Alternatively, at least one lens among the first to seventh lenses 101-107 may function as an aperture stop. For example, an outer portion of the object-side surface or the sensor-side surface of one lens selected from the first to seventh lenses 101-107 may function as an aperture stop for controlling the amount of light. For example, at least one of the sensor-side surface of the third lens 103 and the object-side surface of the fourth lens 104 may function as an aperture stop.

The object-side surface and the sensor-side surface of the first to seventh lenses 101-107 may be aspherical. At least one of the first to seventh lenses 101-107 may be made of a glass mold material. For example, at least one of the third and fourth lenses 103 and 104 may be a glass mold lens, and specifically, the fourth lens 104 may be made of a glass mold material. The first, second, third, fifth, sixth, seventh, and eighth lenses 101, 102, 103, 105, 106, and 107 may be made of a plastic material. Since the glass mold lens is arranged in the lens unit 100, the TTL may be reduced.

The optical system 1000 may further include an optical path changing member 400 as shown in FIG. 23. The optical path changing member 400 may reflect light incident from the outside to change the path of the light from the second path OA2 to the first path OA1. The optical path changing member 400 may include a reflector or a prism. For example, the optical path changing member 400 may include a right-angled prism. When the optical path changing member 400 includes a right-angled prism, the optical path changing member 400 may reflect the second path OA2 of the incident light at an angle of 90 degrees to change the first path OA1 of the light. The first path OA1 may be in the direction of the optical axis of the optical system. The optical path changing member 400 may be arranged closer to the object side than the lens unit 100. That is, when the optical system 1000 includes the optical path changing member 400, the optical path changing member 300, the first lens 101, the second lens 102, the third lens 103, the fourth lens 104, the fifth lens 105, the sixth lens 106, the seventh lens 107, the optical filter 500, and the image sensor 300 may be arranged in this order from the object side toward the sensor.

The optical path changing member 400 may change the path of light incident from the outside to a set direction. For example, the optical path changing member 400 may change the second path OA2 of light incident on the optical path changing member 400 in the first direction to the first path OA1 in the second direction, which is the arrangement direction of the lens unit 100. If the optical system 1000 includes the optical path changing member 400, the optical system may be applied to a folded camera, thereby reducing the thickness of the camera. In detail, if the optical system 1000 includes the optical path changing member 400, light incident in a direction Y perpendicular to the surface of the device to which the optical system 1000 is applied may be changed into a direction Z parallel to the surface of the device. Accordingly, the optical system 1000 including the lens unit 100 may have a thinner thickness within the device, thereby reducing the height of the device.

If the optical system 1000 does not include the optical path changing member, the lens unit 100 may be arranged to extend in a direction Y perpendicular to the surface of the device within the device. Accordingly, the optical system 1000 including the lens unit 100 has a high height in the direction Y perpendicular to the surface of the device, and thus it may be difficult to form the optical system 1000 and the device including it thin. However, when the optical system 1000 includes the optical path changing member 400, the lens unit 100 may be arranged to extend in the direction Z parallel to the surface of the device. That is, the optical system 1000 is arranged so that the optical axis OA is parallel to the surface of the device, and may be applied to a folded camera. Accordingly, the optical system 1000 including the lens unit 100 may have a low height in the direction perpendicular to the surface of the device. Therefore, the camera including the optical system 1000 may have a thin thickness within the device, and the thickness of the device may also be reduced.

As another example, the optical path changing member may be arranged between two lenses of the lens unit 100, or may be arranged between the last lens adjacent to the image sensor 300 and the image sensor 300. As another example, the optical path changing member may be provided in multiple pieces. In detail, a plurality of the optical path changing members may be arranged between the object and the image sensor 300. For example, the plurality of optical path changing members may include a first optical path changing member arranged closer to the object side than the lens unit 100, and a second optical path changing member arranged between the last lens and the image sensor 300. Accordingly, the optical system 1000 may have various shapes and heights depending on the camera to which it is applied, and may have improved optical performance.

Referring to FIGS. 1 to 3, the first lens group G1 may include first to third lenses 101, 102, and 103, the second lens group G2 may include fourth and fifth lenses 104 and 105, and the third lens group G3 may include sixth to seventh lenses 106 and 107. The first lens 101 may be closest to the object side of the lens unit 100, and the seventh lens 107 may be closest to the image sensor 300 side. Each of the first to seventh lenses 101-107 may include an object-side surface S1, S3, S5, S7, S9, S11, and S13 and a sensor-side surface S2, S4, S8, S10, S12, and S14.

The first lens 101 may have positive (+) refractive power on the optical axis OA. The first lens 101 may include a plastic or glass material, and may be, for example, a plastic material. The object-side first surface S1 of the first lens 101 may have a convex shape on the optical axis OA, and the sensor-side second surface S2 may have a concave shape on the optical axis OA. That is, the first lens 101 may have a meniscus shape that is convex toward the object side on the optical axis OA. Alternatively, the first lens 101 may have a second surface S2 that is convex at the optical axis OA. At least one or both of the first surface S1 and the second surface S2 may be aspherical. The center thickness CT1 of the first lens 101 is the thickness along the optical axis and may be thicker than the edge thickness ET1. The edge thickness ET1 is the optical axis distance between the edge of the object-side surface of the first lens 101 and the edge of the sensor-side surface. Accordingly, the first lens 101 may improve optical aberration or control incident light. The first surface S1 and the second surface S2 may be provided without a critical point from the optical axis to the end of the effective region.

The second lens 102 may have positive (+) or negative (−) refractive power along the optical axis OA, for example, may have positive refractive power. The second lens 102 may include a plastic or glass material, for example, may be a plastic material. The object-side third surface S3 of the second lens 102 may have a concave shape on the optical axis OA, and the sensor-side fourth surface S4 may have a convex shape on the optical axis OA. The second lens 102 may have a meniscus shape that is convex from the optical axis OA toward the sensor side. Alternatively, the third surface S3 may have a convex shape on the optical axis OA, and the fourth surface S4 may have a convex shape. That is, the second lens 102 may have a shape in which both sides are convex on the optical axis OA. Alternatively, the third surface S3 may have a concave shape on the optical axis OA, and the fourth surface S4 may have a concave shape on the optical axis OA. In contrast, the third surface S3 may have a convex shape on the optical axis OA, and the fourth surface S4 may have a concave shape on the optical axis OA. At least one or both of the third surface S3 and the fourth surface S4 may be aspherical. The third surface S3 and the fourth surface S4 may be provided without a critical point from the optical axis to the end of the effective region.

The third lens 103 may have a refractive power opposite to the refractive power of the first lens 101 on the optical axis OA. That is, the third lens 103 may have a negative (−) refractive power. The third lens 103 may include a plastic or glass material, and may be, for example, a plastic material. The object-side fifth surface S5 of the third lens 103 may have a concave shape on the optical axis OA, and the sensor-side sixth surface S6 may have a concave shape on the optical axis OA. That is, the third lens 103 may have shape in which both sides are concave on the optical axis OA. Differently, the fifth surface S5 may have a convex shape on the optical axis OA, and the sixth surface S6 may have a concave shape on the optical axis OA. That is, the third lens 103 may have a convex meniscus shape toward the object side on the optical axis OA. At least one or both of the fifth surface S5 and the sixth surface S6 may be aspherical. The fifth surface S5 and the sixth surface S6 may be provided without a critical point from the optical axis to the end of the effective region.

The first lens 101 on the object side of the first lens group G1 may have a refractive power opposite to the refractive power of the third lens 103 on the sensor side. Accordingly, the plurality of lenses 101, 102, and 103 included in the first lens group G1 may mutually compensate for the chromatic aberration that occurs. The third lens 103 adjacent to the second lens group G2 in the first lens group G1 may have the highest refractive index within the first lens group G1. For example, the refractive index of the third lens 103 may be 1.6 or less. Accordingly, since the first lens group G1 controls the dispersion of light provided to the second lens group G2, the lens size of the second lens group G2 may be reduced.

The fourth lens 104 may have a positive (+) refractive power on the optical axis OA. The fourth lens 104 may include a plastic or glass material, for example, a glass mold material, and may have a refractive index of less than 1.6. The object-side seventh surface S7 of the fourth lens 104 may have a convex shape on the optical axis OA, and the sensor-side eighth surface S8 may have a convex shape on the optical axis OA. That is, the fourth lens 104 may have a shape in which both sides are convex on the optical axis OA. Alternatively, the seventh surface S7 may be convex in the optical axis OA, and the eighth surface S8 may be concave on the optical axis OA. That is, the fourth lens 104 may have a meniscus shape that is convex toward the object on the optical axis OA. At least one or both of the seventh surface S7 and the eighth surface S8 may be aspherical. The seventh surface S7 and the eighth surface S8 may be provided without a critical point from the optical axis to the end of the effective region.

The fifth lens 105 may have positive (+) or negative (−) refractive power on the optical axis OA. The fifth lens 105 may have the same positive refractive power as the fourth lens 104 on the optical axis OA. The fifth lens 105 may include a plastic or glass material, and may be, for example, a plastic material. The object-side ninth surface S9 of the fifth lens 105 may have a concave shape on the optical axis OA, and the sensor-side tenth surface S10 may have a convex shape on the optical axis OA. That is, the fifth lens 105 may have a convex meniscus shape from the optical axis OA toward the sensor side. At least one or both of the ninth surface S9 and the tenth surface S10 may be aspherical. The ninth surface S9 of the fifth lens 105 may be provided without at least one critical point. As another example, the ninth surface S9 of the fifth lens 105 may have a convex shape on the optical axis OA, and the tenth surface S10 may have a convex shape on the optical axis OA. That is, the fifth lens 105 may have a shape in which both sides are convex on the optical axis OA. Alternatively, the ninth surface S9 may have a concave shape on the optical axis OA, and the tenth surface S10 may have a concave shape on the optical axis OA. In contrast, the ninth surface S9 may have a convex shape on the optical axis OA, and the tenth surface S10 may have a concave shape on the optical axis OA.

The fourth lens 104 has a convex shape on both sides, and the center thickness CT4 of the fourth lens 104 may be thicker than the edge thickness ET4, for example, may be twice or more. Accordingly, the distance CG4 between the fourth lens 104 and the fifth lens 105 may be reduced. The difference in Abbe numbers between the fourth lens 104 and the fifth lens 105 may be greater than 20 or greater than 30, and may be less than 70 at most. Accordingly, the second lens group G2 may minimize the change in chromatic aberration caused by the position changing according to the change in the operation mode.

The sixth lens 106 may have positive (+) or negative (−) refractive power on the optical axis OA, and may have, for example, negative refractive power. The sixth lens 106 may include a plastic or glass material, and may be, for example, a plastic material. The object-side eleventh surface S11 of the sixth lens 106 may have a concave shape on the optical axis OA, and the sensor-side twelfth surface S12 may have a convex shape on the optical axis OA. That is, the sixth lens 106 may have a meniscus shape that is convex from the optical axis OA to the sensor side. Alternatively, the eleventh surface S11 may have a convex shape on the optical axis OA, and the twelfth surface S12 may have a convex shape on the optical axis OA. That is, the sixth lens 106 may have a shape in which both sides are convex on the optical axis OA. Alternatively, the eleventh surface S11 may have a concave shape on the optical axis OA, and the twelfth surface S12 may have a concave shape on the optical axis OA. At least one or both of the eleventh surface S11 and the twelfth surface S12 of the sixth lens 106 may be aspherical. The eleventh surface S11 and the twelfth surface S12 may be provided without a critical point from the optical axis to the end of the effective region.

The seventh lens 107 may have positive (+) or negative (−) refractive power on the optical axis OA, and may have negative refractive power. The seventh lens 107 may have refractive power opposite to that of the fourth and fifth lenses 104 and 105 in the optical axis OA, thereby improving chromatic aberration. The seventh lens 107 may include a plastic or glass material, and may be made of, for example, a plastic material. The object-side thirteenth surface S13 of the seventh lens 107 may have a convex shape on the optical axis OA, and the sensor-side fourteenth surface S14 may have a concave shape on the optical axis OA. That is, the seventh lens 107 may have a meniscus shape that is convex toward the object side on the optical axis OA. As another example, the thirteenth surface S13 may have a convex shape on the optical axis OA, and the fourteenth surface S14 may have a convex shape on the optical axis OA. That is, the seventh lens 107 may have a shape in which both sides are convex on the optical axis OA. Alternatively, the thirteenth surface S13 may have a concave shape on the optical axis OA, and the fourteenth surface S14 may have a convex shape on the optical axis OA. That is, the seventh lens 107 may have a meniscus shape that is convex toward the sensor in the optical axis OA. Alternatively, the thirteenth surface S13 may have a concave shape on the optical axis OA, and the fourteenth surface S14 may have a concave shape on the optical axis OA. That is, the seventh lens 107 may have a shape in which both sides are concave on the optical axis OA. The thirteenth surface S13 and the fourteenth surface S14 of the seventh lens 107 may be provided without a critical point from the optical axis to the end of the effective region.

The fifth lens 105 and the sixth lens 106 may adjust chromatic aberration by setting the Abbe number difference to 10 or less. Accordingly, the second and third lens groups G2 and G3 may minimize chromatic aberration changes caused by positions that change according to mode changes and perform an achromatic role.

At least one of the object-side thirteenth surface S13 and the sensor-side fourteenth surface S14 of the seventh lens 107 may have a critical point, for example, the fourteenth surface S14 may be provided without a critical point, and the thirteenth surface S13 may have a critical point. The critical point is a point where the sign of the slope value with respect to the optical axis OA and the direction perpendicular to the optical axis OA changes from positive (+) to negative (−) or from negative (−) to positive (+), and may mean a point where the slope value is 0. In addition, the critical point may be a point where the slope value of the tangent line passing through the lens surface increases and then decreases, or a point where it decreases and then increases.

The difference between the center thickness CT5 and the edge thickness ET5 of the fifth lens 105 may be 0.9 or more. The difference between the center thickness CT6 and the edge thickness ET6 of the sixth lens 106 may be 0.9 or more. The center thicknesses CT5 and CT6 of the fifth and sixth lenses 105 and 106 may be thicker than the center thicknesses of the other lenses, and may have the thickest thickness. The center thickness CT3 of the third lens 103 may have the thinnest center thickness among the lenses. The center thickness CT2 of the second lens 102 may have the second thinnest center thickness among the lenses. The center thickness CT7 of the seventh lens 107 may be thinner than the edge thickness ET7. Accordingly, the light distribution may be uniformly provided to the periphery of the image sensor 300 due to the difference between the center thickness and the edge thickness of the seventh lens 107.

The third lens group G3 may be closest to the image sensor 300 among the plurality of lens groups G1, G2 and G3. The third lens group G3 may be moved in the direction of the optical axis, and the focus position may be adjusted according to the operation mode due to the variation of the optical axis distance (BFL) between the seventh lens 107 and the image sensor 300. The third lens group G3 may play a role in controlling the chief ray angle (CRA). In detail, the CRA of the optical system 1000 according to the embodiment may be less than about 15 degrees, and the seventh lens 107 of the third lens group G3 may correct the principal ray incidence angle (CRA) of light incident on the image sensor 300 according to each operation mode.

The camera module according to the first embodiment of the invention may include the optical system 1000 described above. The camera module may move the second and third lens groups G2 and G3 among the plurality of lens groups G1, G2 and G3 included in the optical system 1000 in the direction of the optical axis OA. The camera module may include a driving member (not shown) connected to the optical system 1000. The driving member is arranged on the outside of the second lens group G2 and the outside of the third lens group G3, and may move in the direction of the optical axis OA according to the operation mode. The operation mode may include a first mode moving at a first magnification, and a third mode operating at a second magnification different from the first magnification. In this case, the second magnification may be greater than the first magnification. In addition, the operation mode may include a second mode having a magnification between the first and third modes. Here, the first magnification may be the lowest magnification of the optical system 1000, and the second magnification may be the highest magnification of the optical system 1000. The first magnification may be about 2.5 to about 5 magnifications, the second magnification may be about 6 to about 11 magnifications, and the third magnification may be about 4 to about 6 magnifications between the first and second magnifications. The first mode may be a wide mode, the second mode may be a middle mode, and the third mode may be a tele mode. The driving member can move the second and third lens groups G2 and G3 or operate them in an initial mode according to one of the operation modes selected from the first to third modes.

In detail, each of the plurality of driving members is connected to the second lens group G2 or the third lens group G3, and can move the second lens group G2 or the third lens group G3 according to the operation mode. The initial mode may be any one of the first, second, and third modes, for example, the second mode or the middle mode. For example, in the first mode, each of the second lens group G2 and the third lens group G3 may be positioned at a position defined as a first position (Position 1). In the second mode, each of the second lens group G2 and the third lens group G3 may be positioned at a second position (Position 2) defined as closer to the object than the first position. In the third mode, each of the second lens group G2 and the third lens group G3 may be positioned at a third position (Position 3) defined as being closer to the sensor side than the first position. The first position may be an area between the second and third positions.

The first position at which the second lens group G2 is positioned in the first mode may be a region between the second and third positions at which the second lens group G2 is positioned in the second and third modes. The first position at which the third lens group G3 is positioned in the first mode may be an area between the second and third positions at which the third lens group G3 is positioned in the second and third modes.

According to the first embodiment, the optical system 1000 may be configured such that the second lens group G2 and the third lens group G3 may be movable depending on the operation mode, and the first lens group G1 may be arranged at a fixed position. Depending on the operation mode, the second lens group G2 or the third lens group G3 may be movable, and the first lens group G1 may be arranged at a fixed position. In each of the first position, the second position, and the third position depending on the operation mode, the first to third lens groups G1, G2 and G3 may have a set distance from the adjacent lens groups. Accordingly, the optical system 1000 may have a constant TTL (Total track length) and a variable BFL depending on the operation mode, and may control the effective focal length and magnification of the optical system 1000 by controlling the positions of some lens groups.

The effective diameter of the first lens 101 is the largest among the lenses, and the effective diameter of the third lens 103 is the smallest among the lenses. The Abbe number of the fourth lens 104 may be the largest among the lenses, and may be 70 or more. In terms of the absolute value of the focal length, the focal length of the fifth lens 105 may be the largest among the lenses, and as for the difference (absolute value) of the focal lengths between adjacent two lenses, the difference between the fourth and fifth lenses (104 and 105) may be the largest, and the difference between the first and second lenses (101 and 102) may be the smallest. The optical axis distance DG12 between the first lens group G1 and the second lens group G2, and the optical axis distance DG23 between the second lens group G2 and the third lens group G3 may be at least 0.2 mm or more, and at most 8 mm or less, depending on the operation mode. According to the above operation mode, the F number of the optical system 1000 provides a brightness of 2.0 or more, and the F number may be in the range of 2.2 to 3.8. The aperture may be located between the first lens group G1 and the second lens group G2.

The optical system 1000 according to the first embodiment may satisfy at least one or two or more of the mathematical equations described below. Accordingly, the optical system 1000 according to the embodiment may effectively correct aberrations that change according to a change in the operation mode. In addition, the optical system 1000 according to the embodiment may effectively provide an autofocus (AF) function for a subject at various magnifications, and may have a slim and compact structure. Hereinafter, the center thickness of the first to seventh lenses 101-107 may be defined as CT1-CT7, the edge thickness may be defined as ET1-ET7, and the optical axis distance between adjacent two lenses may be defined as CG1-CG6 from the distance between the first and second lenses to the distance between the sixth and seventh lenses. The average effective diameter of the object-side surface and the sensor-side surface of the first to seventh lenses 101-107 may be defined as CA1-CA7, and the effective diameters of the object-side surface and the sensor-side surface of the first lens 101 to the object-side surface and the sensor-side surface of the seventh lens 107 may be defined as CA11 and CA12 to CA71 and CA72. The units of the thickness, distance, and effective diameter values are mm. In addition, the effective diameter may be defined as the case where the lens is circular or partially circular in shape, and as the effective length or the maximum effective length when the lens is partially circular in shape.

$$n\_G1 , n\_G2 , n\_G3 > 1 \qquad [ Equation 1 ]$$

$$( n\_G1 , n\_G2 , n\_G3 are natural numbers )$$

In Equation 1, n_G1, n_G2, n_G3 represent the number of lenses included in each of the first to third lens groups G1, G2 and G3. Here, n_G1>n_G2 and n_G1>n_G3 may have relationships.

$$0.7 < CA 41 / CA 11 < 1.2 \qquad [ Equation 2 ]$$

In Equation 2, CA41 is the maximum effective diameter of the seventh surface S7 of the fourth lens 104, and CA11 is the maximum effective diameter of the first surface S1 of the first lens 101. When Equation 2 is satisfied, a high entrance pupil diameter (EPD) compared to the optical system may be provided.

$$2 < CT 1 / CT 3 < 5 \qquad [ Equation 3 ]$$

In Equation 3, CT1 is the thickness (mm) of the first lens 101 along the optical axis, and CT3 is the thickness of the third lens 103 along the optical axis. If Equation 3 is satisfied, the aberration characteristics of the optical system 1000 may be improved. Preferably, 2.5<CT1/CT3<4 may be satisfied.

$$0 < CT 1 / CT 4 < 1.5 \qquad [ Equation 4 ]$$

In Equation 4, CT3 means the thickness (mm) of the fourth lens 104 along the optical axis OA. If the optical system 1000 according to the embodiment satisfies Equation 4, the optical system 1000 can improve the aberration characteristics. Preferably, 0.5<CT1/CT4<1 may be satisfied.

$$0 < ET 3 / CT 3 < 1 \qquad [ Equation 5 ]$$

In Equation 4, ET3 means the thickness (mm) in the direction of the optical axis OA at the edge, which is the end of the effective region of the third lens 103. When the optical system 1000 according to the embodiment satisfies Equation 5, the optical system 1000 can improve the distortion characteristics. Preferably, 0.3<ET3/CT3<0.7 may be satisfied.

$$G 1 F < 0 \qquad [ Equation 6 ]$$

In Equation 6, GIF is the effective focal length (EFL) of the first lens group G1 and may have a value smaller than 0. It is the composite focal length of the first to third lenses. When Equation 6 is satisfied, the optical aberration of the optical system or the optical aberration of the first lens group G1 may be improved.

$$CRA < 20 degrees \qquad [ Equation 7 ]$$

In Equation 7, CRA (Chief Ray Angle) is the chief ray incident angle, and in the optical system, the incident angle of the chief ray may be less than 20 degrees at the most, and may be 15 degrees or less, depending on the first, second, and third modes. The first mode may be a wide mode, the second mode may be a middle mode, and the third mode may be a tele mode. Here, in the case of the first mode (Wide mode), the chief ray incident angle may be greater than the chief ray incident angle in the case of the second mode in a field of 1.0. In the case of the third mode (Tele mode), the chief ray incident angle may be 11 degrees or less in a field of 1.0, and the chief ray incident angle of the second mode may be smaller than the chief ray incident angle of the first mode. When Equation 6 is satisfied, the peripheral light ratio may be secured.

$$3.5 < ( TTL / DG 1 ) \qquad [ Equation 8 ]$$

In Equation 8, DG1 is the optical axis distance of the first lens group G1, for example, the optical axis distance from the center of the object-side surface of the first lens 101 to the center of the sensor-side surface of the third lens 103. For example, the DG1 means the distance (mm) from the optical axis OA of the first surface S1 of the first lens 101 to the sixth surface S6 of the third lens 103. The TTL (Total track length) means the distance (mm) from the object-side first surface S1 of the first lens 101 to the imaging surface of the image sensor 300 on the optical axis OA. When the optical system 1000 according to the embodiment satisfies Equation 8, the optical system 1000 has a relatively small TTL and can secure a peripheral light ratio. Preferably, 4<(TTL/DG1)<6 may be satisfied.

$$2 < TTL / EPD 3 < 7 \qquad [ Equation 9 ]$$

In Equation 9, EPD3 means the size of the entrance pupil diameter (EPD) of the optical system 1000 when operating in the third mode, i.e., Tele mode. When the optical system 1000 according to the embodiment satisfies Equation 9, the optical system 1000 can secure a bright image when operating in the third mode, and may be a minimum condition for securing an F number of 4 or less in Tele mode. Preferably, 3<TTL/EPD3<5 may be satisfied.

$$3 < TTL / EPD 1 < 7 \qquad [ Equation 9 - 1 ]$$

$$2 < TTL / EPD 2 < 6 \qquad [ Equation 9 - 2 ]$$

$$( TTL / EPD 3 ) < ( TTL / EPD 2 ) < ( TTL / EPD 1 ) \qquad [ Equation 9 - 3 ]$$

In Equations 9-1 to 9-3, EPD1 is the size of the entrance pupil diameter of the optical system in the first mode (Wide mode), and EPD2 is the size of the entrance pupil diameter of the optical system in the second mode (Middle mode). If the optical system satisfies the above conditions, it can secure a bright image according to each mode.

$$2 < CT\_Max / CT\_Min < 6 \qquad [ Equation 10 ]$$

In Equation 10, CT_Max is the thickest thickness among the center thicknesses of the lenses, and CT_Min is the thinnest thickness among the center thicknesses of the lenses, and if Equation 10 is satisfied, the aberration characteristics of the optical system may be improved. Preferably, 3<CT_Max/CT_Min<5.5 may be satisfied.

$$1 < CA\_Max / CA\_Min < 3 \qquad [ Equation 11 ]$$

In Equation 11, CA_Max is the largest effective diameter among the lenses, and CA_Min is the smallest effective diameter among the lenses. If Equation 11 is satisfied, the optical performance of the optical system may be maintained, and a camera module for a slim or compact structure may be provided.

$$0.1 < Σ CG\_Wide / TTL < 0.6 \qquad [ Equation 12 ]$$

In Equation 12, ECG_Wide is the sum of the center distances between adjacent lenses in the first mode. If the optical system satisfies Equation 12, the center distance DG12 between the first and second lens groups and the center distance between the second and third lens groups may be set according to the wide mode. The center distance DG12 between the first and second lens groups may be the center distance CG3 between the third and fourth lenses 103 and 104, and may vary depending on the operating mode. The center distance DG23 between the second and third lens groups may be the center distance CG5 between the fifth and sixth lenses 105 and 106, and may vary depending on the operating mode.

$$0.05 < Σ CG\_Mid / TTL < 0.4 \qquad [ Equation 12 - 1 ]$$

$$0 < Σ CG\_Tele / TTL < 0.3 \qquad [ Equation 12 - 2 ]$$

In Equations 12-1 and 12-2, ΣCG_Mid is the sum of the center distances between adjacent lenses in the second mode, and ΣCG_Tele is the sum of the center distances between adjacent lenses in the third mode. If the optical system satisfies the Equations 12-1 and 12-2, the center distance DG12 between the first and second lens groups and the center distance between the second and third lens groups may be set according to the middle mode and the tele mode. If the optical system 1000 according to the first embodiment satisfies at least one or two of the Equations 1 to 12, the optical system 1000 may have a slim structure. In addition, the optical system 1000 may have improved assemblability and a mechanically stable shape.

$$0.5 < DG 1 / DG 2 < 3 \qquad [ Equation 13 ]$$

In Equation 13, DG1 is the optical axis distance of the first lens group G1, and means, for example, the optical axis distance between the first surface S1 of the first lens 101 and the sixth surface S6 of the third lens 103. DG2 is the optical axis distance of the second lens group G2, for example, the optical axis distance between the seventh surface S7 of the fourth lens 104 and the tenth surface S10 of the fifth lens 105. In Equation 13, the TTL may be adjusted by setting the optical axis distances of the first and second lens groups G1 and G2. Preferably, 0.5<DG1/DG2<1 may be satisfied.

$$0.5 < DG 2 / DG 3 < 2 \qquad [ Equation 14 ]$$

In Equation 14, DG2 means the optical axis distance of the second lens group G2, for example, the optical axis distance between the seventh surface S7 of the fourth lens 104 and the tenth surface S6 of the fifth lens 105. DG3 means the optical axis distance of the third lens group G3, for example, the optical axis distance between the eleventh surface S11 of the sixth lens 106 and the fourteenth surface S14 of the seventh lens 107. Preferably, 0.8<DG2/DG3<1.5 may be satisfied. When the optical system 1000 according to the embodiment satisfies at least one of the Equations 13 and 14, it has a relatively small TTL and can provide various magnifications according to at least three mode changes.

$$0 < CG 2 / TTL < 0.2 \qquad [ Equation 15 ]$$

In Equation 15, the CG2 is the optical axis distance between the second lens 102 and the third lens 103. When the optical system 1000 satisfies Equation 15, the optical system 1000 has a relatively small TTL and may have improved optical characteristics by controlling stray light incident on the first lens group G1. Preferably, 0<CG2/TTL<0.1 may be satisfied.

$$3 < TTL / DG 2 < 10 \qquad [ Equation 16 ]$$

In Equation 16, DG2 is the optical axis distance of the second lens group G2. When the optical system 1000 according to the embodiment satisfies Equation 16, the optical system 1000 has a relatively small TTL and can improve chromatic aberration characteristics.

$$20 < \vert Vd 4 - Vd 5 \vert < 70 \qquad [ Equation 17 ]$$

In Equation 17, Vd4 means the Abbe Number of the fourth lens 104, and Vd5 means the Abbe Number of the fifth lens 105. If the absolute value of the difference in Abbe numbers between the fourth and fifth lenses of the optical system 1000 according to the embodiment satisfies Equation 17, the optical system 1000 can improve chromatic aberration characteristics.

$$15 < \vert Vd 7 - Vd 6 \vert < 60 \qquad [ Equation 18 ]$$

In Equation 18, Vd7 means the Abbe Number of the seventh lens, and Vd6 means the Abbe Number of the sixth lens. If the absolute value of the difference in Abbe numbers between the sixth and seventh lenses satisfies Equation 18, the optical system 1000 can improve chromatic aberration characteristics.

$$1.6 < n 2 \qquad [ Equation 19 ]$$

In Equation 19, n2 means the refractive index of the d-line of the second lens 102. When the optical system 1000 according to the embodiment satisfies Equation 19, the incident light may be dispersed, and the effective region of the lens arranged after the second lens 102 may be secured. The refractive index of the fourth and seventh lenses 104 and 107 may be less than 1.6, and the refractive index of the fourth lens 104 may be the smallest among the lenses. Among the lenses, the number of lenses having a refractive index of 1.63 or higher is 2 or more.

$$1 < L 1 R 1 / L 3 R 2 < 2.5 \qquad [ Equation 20 ]$$

In Equation 20, L1R1 means the radius of curvature of the object-side first surface S1 of the first lens 101, and L3R2 means the radius of curvature of the sensor-side sixth surface S6 of the third lens 103. When the optical system 1000 according to the embodiment satisfies Equation 20, the optical system 1000 can control stray light incident on the first lens group G1.

$$1.5 < L 1 R 1 / L 4 R 1 < 3.5 \qquad [ Equation 21 ]$$

In Equation 21, L1R1 means the radius of curvature of the object-side first surface S1 of the first lens 101, and L4R1 means the radius of curvature of the object-side seventh surface S7 of the fourth lens 104. When the optical system 1000 according to the embodiment satisfies Equation 21, the optical system 1000 may have good optical performance at various magnifications.

$$0 < L 3 R 2 / L 4 R 1 < 2 \qquad [ Equation 22 ]$$

In Equation 22, L3R2 means the radius of curvature of the sensor-side sixth surface S6 of the third lens 103, and L4R1 means the radius of curvature of the object-side seventh surface S7 of the fourth lens 104. When the optical system 1000 according to the embodiment satisfies the Equation 22, the optical system 1000 may have good optical performance in the periphery portion of the field of view (FOV) when operating at various magnifications of at least three modes.

$$1 < L 1 R 1 / L 7 R 2 < 3 \qquad [ Equation 23 ]$$

In Equation 23, L1R1 means the radius of curvature of the object-side first surface S1 of the first lens 101, and L7R2 means the radius of curvature of the sensor-side fourteenth surface S14 of the seventh lens 107. When the optical system 1000 according to the embodiment satisfies the Equation 23, the optical system 1000 may have good optical performance in the center and periphery portions of the field of view (FOV).

$$0 < Mode 12 \_mG 2 / TTL < 0.5 \qquad [ Equation 24 ]$$

In Equation 24, Mode12_mG2 means the difference in the center distance (unit: mm) after the movement of the second lens group G2 when changing from the second mode to the first mode or from the first mode to the second mode. In detail, the Mode12_mG2 represents the movement distance of the second lens group G2 in the first and second modes, and means the difference value between the optical axis distance between the first and second lens groups G1 and G2 in the first mode and the optical axis distance between the first and second lens groups G1 and G2 in the second mode. When the optical system 1000 according to the embodiment satisfies Equation 24, the optical system 1000 can minimize the movement distance of the second lens group G2 when the magnification is changed, so that the optical system 1000 may have a slim structure. In addition, the movement distance may be minimized when controlling the position of the second lens group G2, thereby achieving improved power consumption characteristics.

$$0 < Mode 23 \_mG 2 / TTL < 0.5 \qquad [ Equation 25 ]$$

In Equation 25, Mode23_mG2 means the difference (unit: mm) in the center distance after movement of the second lens group G2 when operating from the second mode to the third mode, or from the third mode to the second mode. In detail, Mode23_mG2 means the difference value between the optical axis distance between the first and second lens groups G1 and G2 in the second mode and the optical axis distance between the first and second lens groups G1 and G2 in the third mode. The maximum movement distance of the second lens group G2 may be greater than the maximum movement distance of the third lens group G3. When the optical system 1000 according to the embodiment satisfies the Equation 25, the optical system 1000 can minimize the movement distance of the second lens group G2 when the magnification is changed, so that the optical system 1000 may have a slim structure. In addition, the movement distance may be minimized when the position of the second lens group G2 is controlled, so that it may have improved power consumption characteristics.

$$0.3 < Mode12\_mG2 / DG 2 < 1 \qquad [ Equation 26 ]$$

Equation 26 means the difference in center distance (unit: mm) after the movement of the second lens group G2 when Mode12_mG2 operates from the first mode to the second mode, or from the second mode to the first mode. When the optical system 1000 according to the embodiment satisfies Equation 26, the optical system 1000 can minimize the movement distance of the second lens group G2 when the magnification is changed, so that the optical system 1000 may have a slim structure. In addition, the movement distance may be minimized when the position of the second lens group G2 is controlled, so that the optical system 1000 may have improved power consumption characteristics. DG2 is the optical axis distance of the second lens group G2. When the optical system 1000 according to the embodiment satisfies Equation 26, the optical system 1000 can minimize the movement distance of the second lens group G2 when the magnification is changed, so that the optical system 1000 may have a slim structure. In addition, the movement distance may be minimized when the position of the second lens group G2 is controlled, so that the optical system 1000 may have improved power consumption characteristics.

$$0 < Mode23\_mG3 / DG 3 < 0.5 \qquad [ Equation 27 ]$$

In Equation 27, Mode23_mG3 means the difference in the center distance after the movement of the third lens group G3 when changing from the second mode to the third mode or from the third mode to the second mode. DG3 is the optical axis distance of the third lens group G3. When the optical system 1000 according to the embodiment satisfies Equation 27, the optical system 1000 can minimize the movement distance of the third lens group G3 when the magnification is changed, so that the optical system 1000 may have a slim structure. In addition, since the movement distance may be minimized when controlling the position of the third lens group G3, it may have improved power consumption characteristics.

$$0 < ( CT 1 / ET 1 ) / ( CT 3 / ET 3 ) < 1 \qquad [ Equation 28 ]$$

In Equation 28, CT1/ET1 is a value obtained by dividing the thickness of the optical axis of the first lens 101 by the thickness at the end, and CT3/ET3 is a value obtained by dividing the thickness of the optical axis of the third lens 103 by the thickness at the end. If the value obtained by dividing the center thickness and the end thickness of the first and third lenses 101 and 103 satisfies Equation 28 at the above ratio, chromatic aberration may be improved and incident light may be controlled.

$$0.5 < ( CT 1 / ET 1 ) / ( CT 7 / ET 7 ) < 1.5 \qquad [ Equation 29 ]$$

In Equation 29, CT1/ET1 is a value obtained by dividing the thickness of the optical axis of the seventh lens 107 by the thickness at the end. If the values obtained by dividing the center thickness and the end thickness of the first and seventh lenses 101 and 107 satisfy the Equation 29 with the above ratio, chromatic aberration may be improved and incident light may be controlled.

$$1 < Mode 1 ( DG 12 / DG 23 ) < 5 \qquad [ Equation 30 ]$$

In Equation 30, Model (DG12/DG23) represents the ratio between the center distance DG12 between the first and second lens groups in the first mode and the center distance DG23 between the second and third lens groups. If the optical system 1000 according to the embodiment satisfies Equation 30, the optical system 1000 may have improved optical characteristics at the first magnification. In detail, the optical system 1000 may have improved aberration characteristics at the first magnification and can improve optical performance at the center and periphery portions of the FOV.

$$0 < M ode 3 ( DG 12 / DG 23 ) < 0.7 \qquad [ Equation 31 ]$$

In Equation 31, Mode3 (DG12/DG23) represents the ratio between the center distance DG12 between the first and second lens groups in the third mode and the center distance DG23 between the second and third lens groups. When the optical system 1000 according to the embodiment satisfies Equation 31, the optical system 1000 may have improved optical characteristics at the second magnification. In detail, the optical system 1000 may have improved aberration characteristics at the second magnification and may improve optical performance at the periphery portion of the FOV.

$$0.5 < TD 2 / TTL < 1 \qquad [ Equation 32 ]$$

In Equation 32, TD2 is the optical axis distance from the center of the object-side surface of the first lens to the center of the sensor-side surface of the seventh lens in the second mode. When the optical system 1000 according to the embodiment satisfies Equation 32, the optical system 1000 may have improved optical characteristics in the middle mode. In detail, the optical system 1000 may have improved aberration characteristics in the middle mode and can improve optical performance in the periphery portion of the FOV.

$$0.7 < TD 1 / TD 2 < 1.5 \qquad [ Equation 33 ]$$

In Equation 33, TD1 is an optical axis distance from the center of the object-side surface of the first lens to the center of the sensor-side surface of the seventh lens in the first mode. When the optical system 1000 according to the embodiment satisfies Equation 33, the optical system 1000 may have improved optical characteristics in the first and second modes. In detail, the optical system 1000 may have improved aberration characteristics in the first and second modes and can improve optical performance in the periphery portion of the FOV.

$$12 mm < TD 3 < TD 2 < TD 1 < 20 mm \qquad [ Equation 34 ]$$

Equation 34 is a drawing comparing the optical axis distances of lenses in the first, second, and third modes, and TD3 is the optical axis distance from the center of the object-side surface of the first lens to the center of the sensor-side surface of the seventh lens in the third mode. When the optical system 1000 according to the embodiment satisfies Equation 34, the optical system 1000 may have improved optical characteristics in the first, second, and third modes. In detail, the optical system 1000 may have improved aberration characteristics in the first, second, and third modes and improve the optical performance of the peripheral portion of the FOV.

$$0.1 < BFL 2 / TTL < 1 \qquad [ Equation 35 ]$$

In Equation 35, BFL2 (Back focal length 2) is the optical axis distance from the center of the sensor-side surface of the seventh lens to the imaging surface of the image sensor in the second mode. When the optical system 1000 according to the embodiment satisfies Equation 35, the optical system 1000 can adjust the focus position toward the imaging surface of the image sensor 300 in the second mode. In detail, the optical system 1000 has improved optical characteristics in the second mode and can improve the optical performance of the peripheral portion of the FOV. Preferably, it can satisfy 0.1<BFL2/TTL<0.5.

$$2 < BFL 3 / BFL 1 < 4 \qquad [ Equation 36 ]$$

In Equation 36, BFL3 is the optical axis distance from the center of the sensor-side surface of the seventh lens to the imaging surface of the image sensor in the third mode. When the optical system 1000 according to the embodiment satisfies Equation 36, the optical system 1000 can adjust the focus position toward the imaging surface of the image sensor 300 in the first and third modes. In detail, the optical system 1000 has improved optical characteristics in the first and third modes and can improve optical performance in the peripheral portion of the FOV. Preferably, it can satisfy 2<BFL3/BFL1<3.3.

$$1.5 < TD 3 / BFL 3 < 3 \qquad [ Equation 37 ]$$

Equation 37 is a value comparing the optical axis distance (TD3) between the center of the object-side surface of the first lens and the center of the sensor-side surface of the seventh lens in the third mode, and the optical axis distance (BFL3) from the center of the sensor-side surface of the seventh lens 107 to the imaging surface of the image sensor. When the optical system 1000 according to the embodiment satisfies Equation 37, the optical system 1000 may have improved optical characteristics in the third mode. In detail, the optical system 1000 may have improved aberration characteristics in the third mode and may improve optical performance in the periphery portion of the FOV.

$$2 < Mode\_CG \_Max / Mode\_CG \_Min < 8 \qquad [ Equation 38 ]$$

In Equation 38, Mode_CG_Max means the maximum center distance among the center distances between the first to seventh lenses in the first, second, and third modes, and Mode_CG_Min means the minimum center distance among the center distances between the first to seventh lenses in the first, second, and third modes. When the optical system satisfies Equation 38, the TTL and the optical axis distances of the lenses according to each mode may be adjusted.

$$1 < BFL 1 < 5 \qquad [ Equation 39 ]$$

Equation 39 represents the optical axis distance between the seventh lens and the image sensor in the first mode. When the optical system satisfies Equation 39, the focus position on the imaging surface of the image sensor in the first mode may be adjusted.

$$30 < Aver\_Abbe < 50 \qquad [ Equation 40 ]$$

In Equation 40, Aver_Abbe is the average of Abbe numbers of the first to seventh lenses. When the optical system satisfies Equation 40, the optical system 1000 may have improved aberration characteristics and resolution.

$$1.5 < Aver\_Index < 1.8 \qquad [ Equation 41 ]$$

In Equation 40, Aver_Index is the average of refractive indices of the first to seventh lenses. When the optical system satisfies Equation 41, the optical system 1000 may have improved aberration characteristics and resolution.

$$10 < \sum Abbe / \sum Index < 40 \qquad [ Equation 41 - 1 ]$$

In Equation 41-1, ΣAbbe means the sum of the Abbe numbers of each of the plurality of lenses. ΣIndex means the sum of the refractive indices of each of the plurality of lenses. When the optical system 1000 according to the embodiment satisfies Equation 41-1, the optical system 1000 may have improved aberration characteristics and resolution. Preferably, Equation 41-1 can satisfy 20<ΣAbbe/ΣIndex<35. Preferably, the condition of (ΣAbb−ΣIndex)<300 may be satisfied.

$$2 < \vert G 1 F / G 2 F \vert < 4 \qquad [ Equation 42 ]$$

In Equation 42, GIF represents the effective focal length (EFL) of the first lens group G1, and G2F represents the effective focal length of the second lens group G2. G2F is the composite focal length of the fourth and fifth lenses. When Equation 42 is satisfied, the size of the optical system, for example, the TTL, may be reduced. Preferably, G2F>0 is satisfied. G3F is the composite focal length of the sixth to seventh lenses, and G3F<0, and the condition of |G1F|>|G3F|>G2F may be satisfied.

$$1 < M 2 F / M 1 F < 10 \qquad [ Equation 43 ]$$

In Equation 43, MIF is the effective focal length of the optical system in the first mode, and M2F is the effective focal length of the optical system in the second mode. Preferably, 1<M2F/M1F<3 may be satisfied. When the optical system satisfies Equation 43, the effective focal length may be adjusted according to the first and second modes.

$$1 < M 3 F / M 2 F < 10 \qquad [ Equation 43 - 1 ]$$

In Equation 43, M3F is the effective focal length of the optical system in the third mode. Preferably, 1<M3F/M2F<3 may be satisfied, and the condition of (M3F/M1 F)>(M3F/M2 F) may be satisfied. When the optical system satisfies Equation 43-1, the effective focal length may be adjusted according to the second and third modes.

$$2 < M 2 F / EPD 2 < 7 \qquad [ Equation 44 ]$$

In Equation 44, M2F is the effective focal length of the optical system in the second mode (Middle mode), and EPD2 means the size of the EPD of the optical system 1000 in the second mode. When the optical system 1000 according to the embodiment satisfies Equation 44, the optical system 1000 can secure a bright image when operating in the second mode. [Equation 45] 0.1<M1F/EPD1<3

In Equation 34, MIF is the effective focal length of the optical system in the first mode (Wide mode), and EPD1 means the size of the EPD of the optical system 1000 when the first mode is operated. When the optical system 1000 according to the embodiment satisfies Equation 45, the optical system 1000 can secure a bright image when the first mode is operated.

$$M 1 F < M 2 F < M 3 F \qquad [ Equation 46 ]$$

In Equation 46, M1F, M2F, and M3F mean the effective focal lengths of the optical system in the first, second, and third modes. The effective focal length in the third mode may be the largest, and the effective focal length in the first mode may be the smallest.

$$0 < TTL / M 2 F < 2 \qquad [ Equation 47 ]$$

Equation 47 can adjust TTL by comparing the effective focal length in TTL and the second mode. Preferably, 1<TTL/M2F<2 may be satisfied.

$$0.1 < TTL / M 1 F < 5 \qquad [ Equation 48 ]$$

Equation 47 can adjust TTL by comparing the effective focal length in TTL and the first mode. Preferably, 1<TTL/M1F<4 may be satisfied.

$$1 < CA\_Max / ImgH < 3 \qquad [ Equation 49 ]$$

In Equation 49, CA_Max means the size (CA) of the largest effective diameter among the lens surfaces of the lens unit 100 included in the optical system 1000. ImgH is the distance from the 0 field area of the image sensor 300 that overlaps the optical axis OA to the 1.0 field area of the image sensor 300. The ImgH means ½ of the diagonal length of the effective region of the image sensor 300. When the optical system 1000 according to the embodiment satisfies the Equation 49, the optical system 1000 may be provided in a slim and compact manner. In addition, the optical system 1000 can implement high resolution and high image quality. The range of the ImgH is in the range of 2 mm to 3 mm.

$$5 < TTL / ImgH < 12 \qquad [ Equation 50 ]$$

When the optical system 1000 satisfies the Equation 39, the optical system 1000 may have a smaller TTL, so the optical system 1000 may be provided in a slim and compact manner. Preferably, it may be in the range of 6<TTL/ImgH<10.

$$1 < BFL 2 / ImgH < 3 \qquad [ Equation 51 ]$$

If the optical system 1000 according to the embodiment satisfies Equation 51, it may secure the BFL required for a small image sensor of less than 1 inch. In addition, if the optical system 1000 satisfies Equation 51, the optical system 1000 may operate at various magnifications while maintaining TTL, and may have excellent optical characteristics at the center and periphery portions of the FOV. Preferably, it may be in the range of 2<BFL2/ImgH<3.

$$2 < BFL 3 / ImgH < 4 \qquad [ Equation 52 ]$$

If the optical system 1000 according to the embodiment satisfies Equation 52, it may secure the BFL required for a small image sensor of less than 1 inch. In addition, when the optical system 1000 satisfies the Equation 51, the optical system 1000 can operate at various magnifications while maintaining TTL, and may have excellent optical characteristics at the center and periphery portions of the FOV. Preferably, 2.5<BFL3/ImgH<3.5 may be satisfied.

$$1 < EPD 1 < EPD 2 < EPD 3 < 7 \qquad [ Equation 53 ]$$

In Equation 53, EPD1, EPD2, and EPD3 represent the sizes of the EPDs of the optical system according to the first to third modes, and can adjust the brightness according to each mode.

0<Max_Distortion<3 [Equation 54]

In Equation 54, distortion means the maximum value or the maximum value of distortion from the center (0.0 F) of the image sensor to the diagonal end (1.0 F) based on the optical characteristics detected by the image sensor 300. When the optical system 1000 satisfies Equation 54, the optical system 1000 can improve the distortion characteristics and set conditions for image processing. Preferably, Distortion<1.5 may be satisfied.

$$8 < FOV 3 < FOV 2 < FOV 1 < 45 \qquad [ Equation 55 ]$$

In Equation 55, FOV1, FOV2, and FOV3 represent the diagonal field of views of the optical system in the first, second, and third modes. FOV represents the diagonal field of views (Degree) of the optical system 1000, and can provide an optical system of less than 45 degrees.

The aspherical coefficient of the second embodiment will refer to Equation 56 of the first embodiment.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 56 ]$$

In Equation 56, Z may represent Sag, which may represent the distance in the direction of the optical axis from an arbitrary position on the aspherical surface to the vertex of the aspherical surface. In addition, Y may represent the distance in the direction perpendicular to the optical axis from an arbitrary position on the aspherical surface to the optical axis. In addition, c may represent the curvature of the lens, and K may represent the conic constant. In addition, A, B, C, D, E, and F may represent aspheric constants.

The optical system 1000 according to the first embodiment may satisfy at least one or two or more of the above-described Equations 1 to 55. Accordingly, the optical system 1000 and the camera module may have improved optical characteristics. In detail, the camera module may effectively correct optical characteristic degradation such as chromatic aberration, vignetting, diffraction effect, and deterioration of peripheral image quality caused by movement of the lens group as the optical system 1000 satisfies at least one or two or more Equations. In addition, the optical system 1000 according to the first embodiment may significantly reduce the movement distance of the lens group and provide an autofocus (AF) function for various magnifications with excellent power consumption characteristics. The camera module according to the first embodiment has improved assembly performance and may have a mechanically stable form as the optical system 1000 satisfies at least one or two of the Equations 1 to 55, and may be provided with a slim structure so that the optical system 1000 and the camera module including it may have a compact structure.

Hereinafter, the optical system 1000 according to the first embodiment and the first to third mode changes will be described in more detail. In the optical system 1000 according to the embodiment, the first lens group G1 may be fixed, and the second lens group G2 and the third lens group G3 may be moved according to the operation mode. The first lens group G1 can include three lenses, for example, the first to third lenses 101, 102, and 103, and the second lens group G2 can include two lenses, for example, the fourth and fifth lenses 104 and 105. In addition, the third lens group G3 may include two lenses, for example, the sixth to seventh lenses 106 and 107. The object-side surface (the seventh surface S7) of the fourth lens 104 may function as an aperture stop, and the optical filter 500 described above may be arranged between the fourth lens group G4 and the image sensor 300.

FIG. 4 shows the radius of curvature on the optical axis OA of the first to seventh lenses 101-107, the center thickness (CT) of the lenses, the center distance (CG) between adjacent components, for example, the lenses, the refractive index (Refractive index) at the d-line, the Abbe number, and the effective diameter (CA). In FIG. 4, the object-side surface and the sensor-side surface of the first to seventh lenses (Lens 1-7) are described as S1 and S2, DG12 is the optical axis distance between the third lens 103 and the fourth lens 104, and DG23 represents the optical axis distance between the fifth lens 105 and the sixth lens 106. DG4 is the optical axis distance between the seventh lens and the optical filter 500, and may be varied according to the movement of the third lens group G3.

TABLE 1

| Leng groups | Lenses | CT/ET |
|---|---|---|
| First lens group | Lens 1 | 1.281 |
| | Lens 1 | 1.198 |
| | Lens 3 | 0.455 |
| Second lens group | Lens 4 | 2.478 |
| | Lens 5 | 0.985 |
| Third lens group | Lens 6 | 0.966 |
| | Lens 7 | 0.812 |

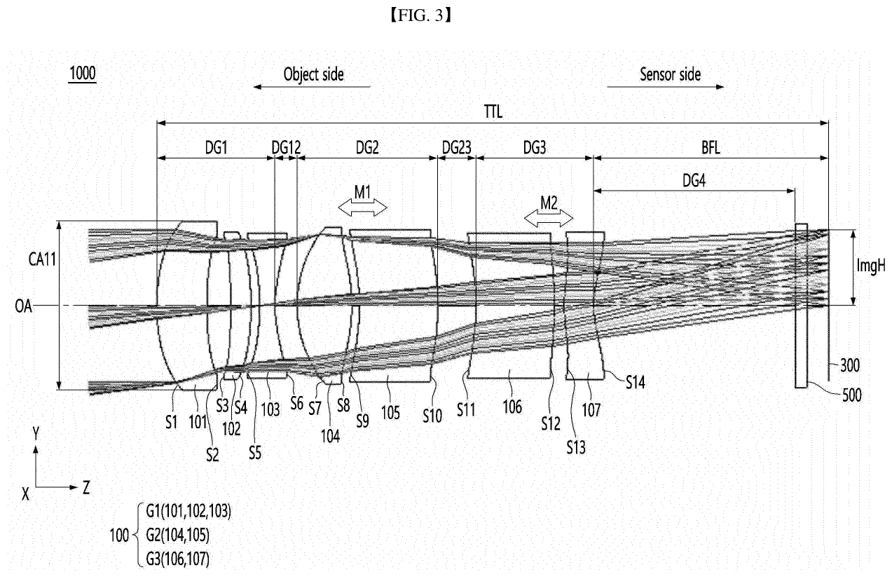

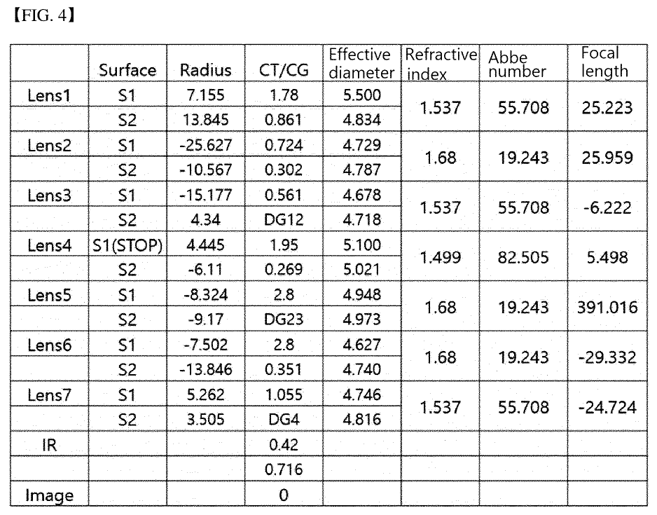

Referring to Table 1, the ratio (CT/ET) of the center thickness (CT) and the edge thickness (ET) of each lens of the lens unit 100 may be different from each other, and the CT/ET value of the fourth lens 104 may be the largest, and the CT/ET value of the third lens may be the smallest. The lenses having the CT/ET value less than 1 may be 4 or less, and may include the second, fifth, sixth, and seventh lenses, and the values having the CT/ET value greater than 2 may be 1, and may include the 4th lens. As shown in FIGS. 1 and 2, the Abbe number Vd4 of the fourth lens 104 included in the second lens group G2 may be 30 or higher or 40 or higher than the Abbe number Vd5 of the fifth lens 105. Since the fourth lens 104 and the fifth lens 105 have the above-described Abbe number difference, the chromatic aberration change that occurs when the magnification changes according to the movement M1 of the second lens group G2 may be minimized. As shown in FIG. 1 and FIG. 3, the Abbe number Vd7 of the seventh lens 107 included in the third lens group G3 may be 20 or more or 30 or more higher than the Abbe number Vd6 of the sixth lens 106. Since the seventh lens 107 and the seventh lens 107 have the above-described Abbe number difference, the chromatic aberration change that occurs when the magnification changes according to the movement M2 of the third lens group G3 may be minimized and/or compensated for, thereby performing an achromatic function.

The camera module according to the first embodiment can obtain information about a subject at various magnifications. In detail, the driving member can control the positions of the second lens group G2 and the third lens group G3, and thereby the camera module can operate at various magnifications. For example, referring to FIGS. 1, 6, and 9, the camera module including the optical system 1000 can operate in the first mode having a first magnification. The first magnification may be about 3 to about 5 times. In detail, in an embodiment, the first magnification may be about 3.5 times.

In the first mode, each of the second lens group G2 and the third lens group G3 may be moved to a set position. Accordingly, each of the first to third lens groups G3 may be arranged at a set interval. For example, the second lens group G2 may be positioned in an area spaced apart from the first lens group G1 by a first interval DG12, and the third lens group G3 may be positioned in an area spaced apart from the second lens group G2 by a second interval DG23. Here, the first and second intervals DG12 and DG23 may mean intervals between the lens groups on the optical axis OA, and may vary depending on the operation mode. When the camera module operates in the first mode, the optical system 1000 may have a TTL value and a BFL1 value at the first position. In addition, the optical system 1000 may have an MIF defined as a first EFL at the first position. In addition, the FOV of the camera module in the first mode may be less than about 35 degrees, and the F-number may be less than about 3.

When the camera module operates in the second mode, the optical system 1000 may have a TTL value and a BFL2 value at the second position. In addition, the optical system 1000 may have an M2F defined as a second EFL at the second position. In addition, the FOV of the camera module in the second mode may be less than about 25 degrees, and the F-number may be less than about 3.4. When the camera module operates in the third mode, the optical system 1000 may have a TTL value and a BFL3 value at the third position. In addition, the optical system 1000 may have an M3F defined as a third EFL at the third position. In addition, the FOV of the camera module in the third mode may be less than about 20 degrees, and the F-number may be less than about 4.

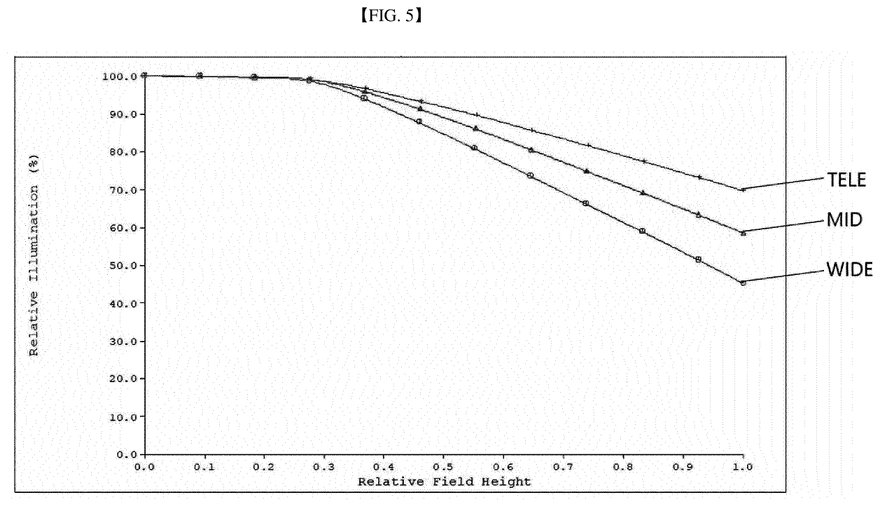

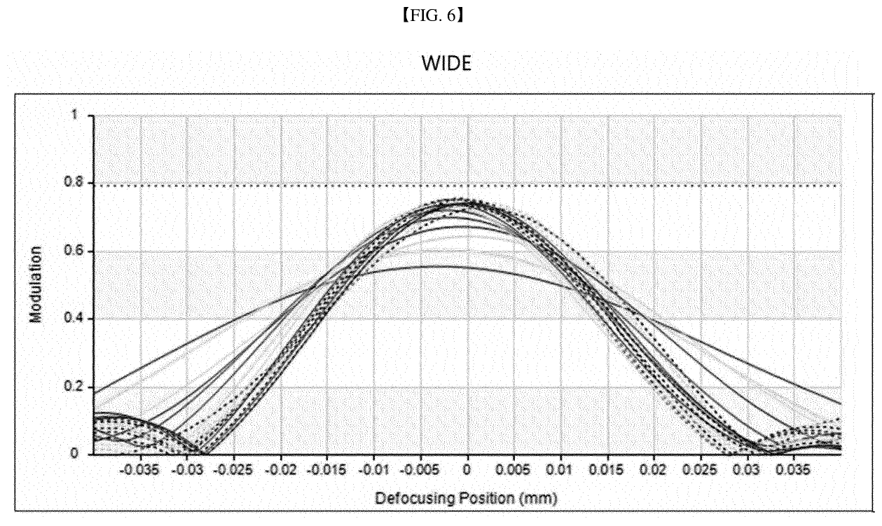

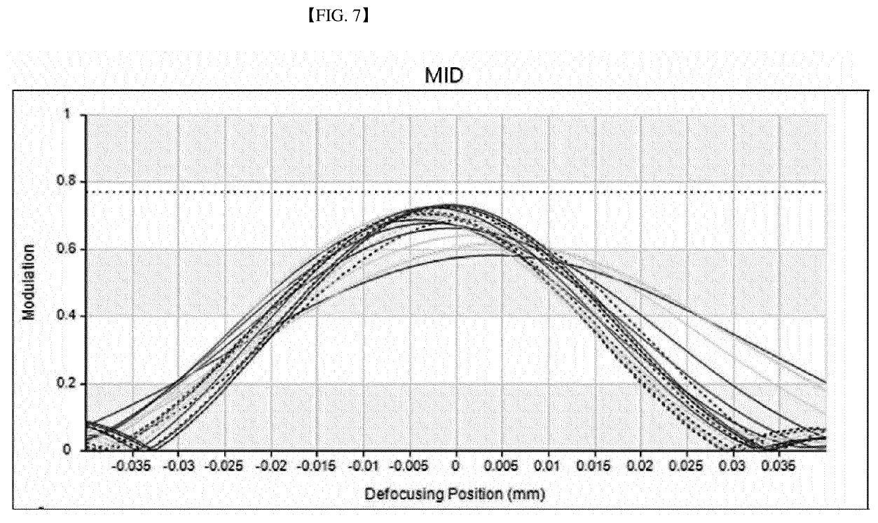

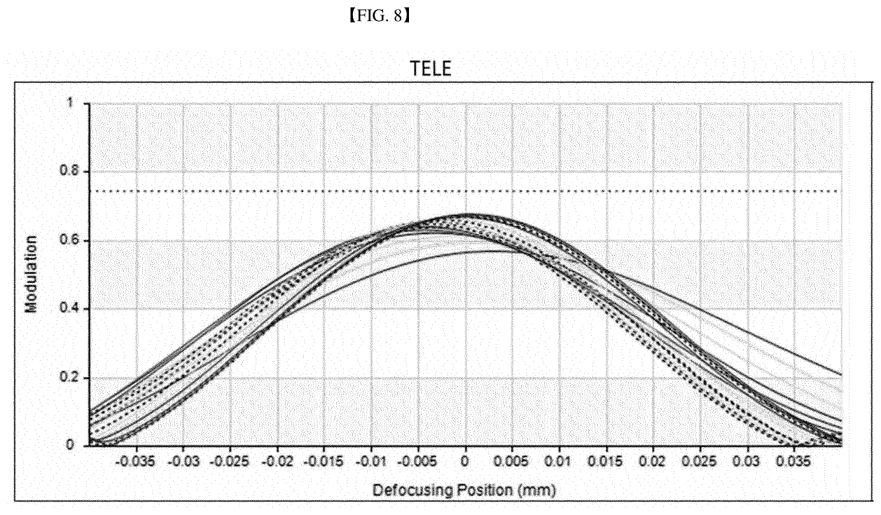

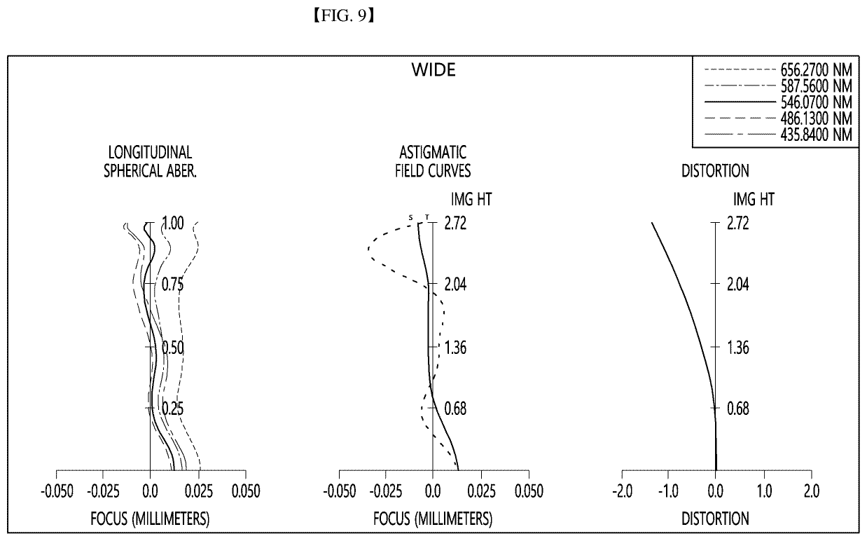

As shown in FIG. 5, the relative illumination (RI) in each mode can change according to the height of the image sensor, and it may be seen that the relative illumination at the periphery or edge of the image sensor is 50% or more. The optical system 1000 may have excellent aberration characteristics as shown in FIGS. 6 and 9 in the first mode. In detail, FIG. 6 is a graph of diffraction MTF characteristics of the optical system 1000 operating in the first mode (first magnification), and FIG. 9 is a graph of aberration characteristics. The diffraction MTF characteristic graph is measured in units of about 0.252 mm over a spatial frequency range of 0.000 mm to 2.2520 mm. In the diffraction MTF graph, T represents the MTF change in spatial frequency per millimeter of a tangential circle, and R represents the MTF change in spatial frequency per millimeter of a radial circle. Here, MTF (Modulation Transfer Function) depends on the spatial frequency of cycles per millimeter.

In the aberration graph of FIG. 9, spherical aberration (Longitudinal spherical aberration), astigmatic field curves, and distortion are measured from left to right. In FIG. 6, the X-axis can represent the focal length (mm) and distortion (%), and the Y-axis can represent the height of the image. In addition, the graph for spherical aberration is a graph for light in the wavelength bands of about 435 nm, about 486 nm, about 546 nm, about 587 nm, and about 656 nm, and the graph for astigmatism and distortion is a graph for light in the wavelength band of 546 nm. In the aberration diagram of FIG. 9, the closer each curve is to the Y-axis, the better the aberration correction function may be interpreted. Referring to FIG. 9, it may be seen that the optical system 1000 according to the embodiment has measurement values close to the Y-axis in almost all regions.

Table 2 and FIG. 3 are about the items of the Equations described above in the optical system 1000 of the embodiment, including the TTL (mm), back focal length BFL, effective focal length F (mm), ImgH (mm), effective diameter CA (mm), thickness (mm), TD (mm), which is the optical axis distance from the first surface S1 to the fourteenth surface S14, the focal lengths F1, F2, F3, F4, F5, F6, and F7 (mm) of each of the first to seventh lenses, the sum of the refractive indices of each lens, the sum of the Abbe numbers of each lens, the sum (mm) of the center thicknesses of each lens, the sum of the center distances between adjacent lenses, the effective diameter, the diagonal FOV (Degree), the edge thickness (ET), the focal lengths of the first and second lens groups, the F number, etc.

TABLE 2

| Items | Values | Items | Values |
|---|---|---|---|
| F1 | 25.22 | ET1 | 1.390 |
| F2 | 25.96 | ET2 | 0.604 |
| F3 | −6.22 | ET3 | 1.233 |
| F4 | 5.50 | ET4 | 0.787 |
| F5 | 391.02 | ET5 | 2.844 |
| F6 | −29.33 | ET6 | 2.900 |
| F7 | −24.72 | ET7 | 1.299 |
| G1F | −21.32 | ΣIndex | 11.150 |
| G2F | 6.92 | ΣAbbe | 307.358 |
| G3F | −11.78 | ΣCT | 11.671 |
| ImgH | 2.52 | ΣCG_Wide | 8.782 |
| TTL | 24 | ΣCG_Mid | 6.025 |
| | | ΣCG_Tele | 3.933 |

Table 3 shows the center distance between the first and second lens groups DG12 according to the first to third modes, the center distance between the second and third lens groups DG23, the center distance between the seventh lens and the optical filter DG4, the effective focal length (EFL) according to each mode, the EPD according to each mode, the optical axis distance (TD) of the lens according to each mode, the F number and field of view, and the BFL according to each mode.

TABLE 3

| Items | First mode | Second mode | Third mode |
|---|---|---|---|
| DG12 (mm) | 4.888 | 2.871 | 0.788 |
| DG23 (mm) | 2.112 | 1.371 | 1.363 |
| DG4 (mm) | 2.411 | 5.204 | 7.202 |
| EFL(M1F/M2F/M3F) | 10.30 | 14.10 | 19.01 |
| EPD(EPD1/EPD2/EPD3) | 4.288 | 4.781 | 5.426 |
| TD(TD1/TD2/TD3) | 20.453 | 17.695 | 15.604 |
| F-number | 2.402 | 2.949 | 3.504 |
| FOV (degree) | 27.850 | 20.338 | 15.080 |
| BFL (BFL1/BFL2/BFL3) | 2.653 | 6.182 | 7.553 |

Tables 4 and 5 are results for the Equations 1 to 55 described above in the optical system 1000 of the embodiment. In detail, it may be seen that the optical system 1000 according to the embodiment satisfies all of the Equations 1 to 55. Accordingly, the optical system 1000 may have good optical performance and excellent optical characteristics in the center and periphery portions of the field of view (FOV).

TABLE 4

| Equations | | Values |
|---|---|---|
| 1 | n_G1, n_G2, n_G3 > 1 | satisfaction |
| 2 | 0.7 < CA41/CA11 < 1.2 | 0.927 |
| 3 | 2 < CT1/CT3 < 5 | 3.173 |
| 4 | 0 < CT1/CT4 < 1.5 | 0.913 |
| 5 | 0 < ET3/CT3 < 1 | 0.455 |
| 6 | G1F < 0 | −21.323 |
| 7 | CRA < 20 | satisfaction |
| 8 | 3.5 < (TTL/DG1) | 4.782 |
| 9 | 2 < TTL/EPD3 < 7 | 4.423 |
| 10 | 2 < CT_Max/CT_Min < | 4.989 |
| | 6 | |
| 11 | 1 < CA_Max/ | 1.189 |
| | CA_Min < 3 | |
| 12 | 0.1 < ΣCG_Wide/TTL < | 0.366 |
| | 0.6 | |
| 13 | 0.5 < DG1/DG2 < 3 | 0.842 |
| 14 | 0.5 < DG2/DG3 < 2 | 1.193 |
| 15 | 0 < CG2/TTL < 0.2 | 0.013 |
| 16 | 3 < TTL/DG2 < 10 | 4.782 |
| 17 | 20 < IVd4 − Vd5I < 70 | 63.262 |
| 18 | 15 < IV7 − V6I < 60 | 36.465 |
| 19 | 1.6 < n2 | 1.680 |
| 20 | 1 < L1R1/L3R2 < 2.5 | 1.649 |
| 21 | 1 < L1R1/L4R1 < 2.5 | 1.610 |
| 22 | 0 < L3R2/L4R1 < 2 | 0.976 |
| 23 | 1 < L1R1/L7R2 < 3 | 2.041 |
| 24 | 0 < Mode12_mG2/TTL < | 0.084 |
| | 0.5 | |
| 25 | 0 < Mode23_mG2/TTL < | 0.031 |
| | 0.5 | |
| 26 | 0 < Mode12_mG2/DG2 < 1 | 0.402 |
| 27 | 0 < Mode23_mG3/DG3 < | 0.176 |
| | 0.5 | |
| 28 | 0 < (CT1/ET1)/ | 0.355 |
| | (CT3/ET3) < 1 | |
| 29 | 0.5 < (CT1/ET1)/ | 0.961 |
| | (CT7/ET7) < 1.5 | |
| 30 | 1 < Model (DG12/DG23) < | 2.315 |
| | 5 | |

TABLE 5

| Equations | | Values |
|---|---|---|
| 31 | 0 < Mode3 (DG12/ | 0.578 |
| | DG23) < 0.7 | |
| 32 | 0.5 < TD2/TTL < 1 | 0.737 |
| 33 | 0.7 < TD1/TD2 < 1.5 | 1.156 |
| 34 | 12 < TD3 < TD2 < TD1 < | satisfaction |
| | 20 | |
| 35 | 0.1 < BFL1/TTL < 1 | 0.258 |
| 36 | 2 < BFL3/BFL1 < 4 | 2.847 |
| 37 | 1.5 < TD3/BFL3 < 3 | 2.066 |
| 38 | 2 < Mode_CG_Max/ | 4.695 |
| | Mode_CG_Min < 8 | |
| 39 | 1 < BFL1 < 5 | 2.653 |
| 40 | 30 < Aver_Abbe < 50 | 43.908 |
| 41 | 1.5 < Aver_Index < 1.8 | 1.593 |
| 42 | 2 < \| G1F/G2F \| < 4 | 3.079 |
| 43 | 1 < M2F/M1F < 10 | 1.369 |
| 44 | 2 < M2F/EPD2 < 7 | 2.949 |
| 45 | 0.1 < M1F/EPD1 < 3 | 2.402 |
| 46 | M1F < M2F < M3F | satisfaction |
| 47 | 0 < TTL/M2F < 2 | 1.702 |
| 48 | 0.1 < TTL/M1F < 5 | 2.330 |
| 49 | 1 < CA_Max/ImgH < 3 | 2.183 |
| 50 | 5 < TTL/ImgH < 12 | 9.524 |
| 51 | 1 < BFL2/ImgH < 3 | 2.453 |
| 52 | 2 < BFL3/ImgH < 4 | 2.997 |
| 53 | 1 < EPD1 < EPD2 < | satisfaction |
| | EPD3 < 7 | |
| 54 | 0 < Max_Distortion < 3 | 1.200 |
| 55 | 8 < FOV3 < FOV2 < | satisfaction |
| | FOV1 < 45 | |

The optical system and camera module according to the second embodiment will be described with reference to FIGS. 12 to 22. In the description of the second embodiment, the same configuration and description as those of the first embodiment will be referred to the description of the first embodiment.

Referring to FIGS. 12 to 22, the optical system 1000 according to the second embodiment may include a plurality of lens groups G1, G2 and G3. The plurality of lens groups G1, G2 and G3 may include a lens group fixed on the object side and a plurality of movable lens groups on the sensor side. The lens group fixed on the object side may be defined as the first lens group G1, and the movable lens groups may be defined as the second lens group G2 on the object side and the third lens group G3 on the sensor side. The second lens group G2 may be arranged between the first lens group G1 and the third lens group G3. The first lens group G1 collects incident light, the second lens group G2 changes the zoom ratio (focal length), and the third lens group G3 can adjust the focus position on the imaging surface of the image sensor 300. The number of lenses of the first lens group G1 may be greater than the number of lenses of the second lens group G2. The number of lenses of the second lens group G2 may be smaller than the number of lenses of each of the first and third lens groups G1 and G3.

The number of lenses of the first lens group G1 may include at least three lenses for adjusting the incident light amount, refractive power, and chromatic aberration. The third lens group G3 may include at least two or three lenses. For example, the optical system may further include at least one lens fixed between the third lens group G3 and the image sensor 300. The first lens group G1 may have at least two lenses having opposite refractive powers. For example, the first lens group G1 may include three lenses. The first lens group G1 may have a greater number of lenses having negative refractive powers than lenses having positive refractive powers.

The first lens group G1 may have a refractive power opposite to that of the second lens group G2. For example, the first lens group G1 may have a negative refractive power, and the second lens group G2 may have a positive refractive power. The second lens group G2 may have a refractive power opposite to that of the third lens group G3. For example, the second lens group G2 may have a positive refractive power, and the third lens group G3 may have a negative refractive power. The third lens group G3 may have negative (−) refractive power. The absolute value of the power of the first lens group G1 may be greater than the absolute value of the power of the second and third lens groups G2 and G3. For example, the absolute value of the power of the first lens group G1 may be at least twice the absolute value of the power of the second lens group G2. Accordingly, the first lens group G1 may disperse the incident light. The first and third lens groups G1 and G3 may have negative power, and the second lens group G2 may have positive power.

Since the first and second lens groups G1 and G2 have opposite refractive powers, the focal length of the second lens group G2 may have a sign opposite to the focal length of the first lens group G1. The focal length of the second lens group G2 may have a positive (+) sign, and the focal length of the first lens group G1 may have a negative (−) sign. The refractive power is the reciprocal of the focal length. Since the second and third lens groups G2 and G3 have opposite refractive powers as described above, the focal length of the second lens group G2 may have a sign (+, −) opposite to the focal length of the third lens group G3. For example, the focal length of the second lens group G2 may have a positive (+) sign, and the focal length of the third lens group G3 may have a negative (−) sign.

The absolute value of the focal length of each of the first to third lens groups G1, G2 and G3 may decrease in the order of the first lens group G1, the third lens group G3, and the second lens group G2. The first lens group G1 is fixed in position, and the second lens group G2 and the third lens group G3 can move in the direction of the optical axis OA, so that the optical system can provide various magnifications by moving the lens groups. The plurality of lenses included in the first lens group G1 may have a set interval. In detail, the center distance between the plurality of lenses included in the first lens group G1 may be a fixed interval according to the operation mode described below. For example, the center distance between the first lens 111 and the second lens 112, and the center distance between the second lens 112 and the third lens 113 may have a constant interval without changing according to the operation mode. Here, the center distance between the lenses can mean the optical axis interval between adjacent lenses.

The second lens group G2 can include a plurality of lenses. In detail, the second lens group G2 can include four or less lenses having opposite refractive powers. The number of lenses included in the second lens group G2 may be one or more less than the number of lenses included in the first lens group G1. For example, the second lens group G2 may include two lenses. The plurality of lenses included in the second lens group G2 may have a set interval. In detail, the center distance between the plurality of lenses included in the second lens group G2 may be a fixed interval according to the operation mode described below. For example, the center distance between the fourth lens 114 and the fifth lens 115 may not change depending on the operation mode and may have a constant interval.

The third lens group G3 may include a plurality of lenses. In detail, the third lens group G3 may include two or more lenses having opposite refractive powers. The number of lenses included in the third lens group G3 having negative refractive power may be greater than the number of lenses having positive refractive power. The number of lenses included in the third lens group G3 may be at least one more than the number of lenses included in the second lens group G2. The number of lenses included in the third lens group G3 may be the same as the number of lenses included in the first lens group G1. For example, the third lens group G3 may include three lenses. The plurality of lenses included in the third lens group G3 may have a set interval. In detail, the center distance between the plurality of lenses included in the third lens group G3 may remain constant without changing even when the operation mode described below changes. For example, the center distance between the sixth lens 116 and the seventh lens 117, and the center distance between the seventh lens 117 and the eighth lens 118 may remain constant without changing depending on the operation mode. The last lens included in the third lens group G3 has a set interval with the image sensor 300 or/and the optical filter 500, and the interval may vary depending on the operation mode.

The optical system 1000 includes a lens unit 100A having the lens groups G1, G2 and G3. The lens unit 100A includes a plurality of lenses, and may include, for example, first to eighth lenses 111-118. The first lens group G1 may include the first to third lenses 111, 112, and 113, and the second lens group G2 may include the fourth and fifth lenses 114 and 115. In addition, the third lens group G3 may include the sixth to eighth lenses 116, 117, and 118. The first to eighth lenses 111-118 and the image sensor 300 may be sequentially arranged along the optical axis OA of the optical system 1000.

At least one of the lenses of the first lens group G1 may include a non-circular lens. At least one of the lenses of the second lens group G2 may include a non-circular lens. At least one of the lenses of the third lens group G3 may include a non-circular lens. For example, the first lens 111 having the largest diameter among the lenses may have different lengths in the first direction Y and the second direction X. The fourth lens 114 of the second lens group G2 may have different lengths in the first direction Y and the second direction X. The optical system 1000 and the camera module according to the second embodiment may have improved assemblability by the non-circular lens(es) and may have a mechanically stable form. In addition, the optical system 1000 may significantly reduce the moving distance of the moving lens group and provide various magnifications.

The optical system 1000 may include an image sensor 300 and an optical filter 500, and reference will be made to the description of the first embodiment. The aperture may control the amount of light incident on the optical system 1000. The aperture stop may be positioned on the periphery of the object-side surface of the first lens 111, or may be arranged between two lenses selected from the first to eighth lenses 111-118. For example, the aperture stop may be arranged on the periphery between the third lens 113 and the fourth lens 114. The aperture stop may be arranged on the periphery of the sensor-side surface of the third lens 113 or the periphery of the object-side surface of the fourth lens 114. Alternatively, at least one lens among the first to eighth lenses 111-118 may function as an aperture stop. For example, the outer surface of the object-side surface or the sensor-side surface of one lens selected from the first to eighth lenses 111-118 may function as an aperture stop for controlling the amount of light. For example, at least one lens surface of the sensor-side surface of the third lens 113 and the object-side surface of the fourth lens 114 may function as an aperture stop.

The object-side surface and the sensor-side surface of the first to eighth lenses 111-118 may be aspherical. At least one of the first to eighth lenses 111-118 may be made of a glass mold material. For example, at least one of the third and fourth lenses 113 and 114 may be a glass mold lens, and specifically, the fourth lens 114 may be made of a glass mold material. The above first, second, third, fifth, sixth, seventh, and eighth lenses 111, 112, 113, 115, 116, 117, and 118 may be made of plastic. Since the lens of the glass mold is arranged in the lens unit 100A, the TTL may be reduced.

The optical system 1000 may further include an optical path changing member 400 as shown in FIG. 23. The optical path changing member 400 may reflect light incident from the outside and change the path of the light from the second path OA2 to the first path OA1. The optical path changing member 400 may include a reflector or a prism. For example, the optical path changing member 400 may include a right-angled prism. When the optical path changing member 400 includes a right-angle prism, the optical path changing member 400 can reflect the second path OA2 of incident light at an angle of 90 degrees to change the first path OA1 of light. The first path OA1 may be in the direction of the optical axis of the optical system. The optical path changing member 400 may be arranged closer to the object side than the lens unit 100A. That is, when the optical system 1000 includes the optical path changing member 400, the optical path changing member 300, the first lens 111 to the eighth lens 118, the optical filter 500, and the image sensor 300 may be arranged in this order from the object side toward the sensor side. The description of the optical path changing member 400 will be referred to in the first embodiment.

Referring to FIGS. 12 to 14, the first lens group G1 may include first to third lenses 111, 112, and 113, the second lens group G2 may include fourth and fifth lenses 114 and 115, and the third lens group G3 may include sixth to eighth lenses 116, 117, and 118.

The first lens 111 may be arranged closest to the object side of the lens unit 100A, and the eighth lens 118 may be arranged closest to the image sensor 300 side. The first lens 111 may have positive (+) refractive power on the optical axis OA. The first lens 111 may include a plastic or glass material, and may be, for example, a plastic material. The object-side first surface S1 of the first lens 111 may have a convex shape on the optical axis OA, and the sensor-side second surface S2 may have a concave shape on the optical axis OA. That is, the first lens 111 may have a meniscus shape that is convex from the optical axis OA to the object side. Differently, the first lens 111 may have a second surface S2 that is convex in the optical axis OA. At least one or both of the first surface S1 and the second surface S2 may be aspherical. The center thickness CT1 of the first lens 111 is a thickness in the optical axis, and may be thicker than the edge thickness ET1. The edge thickness ET1 is an optical axis distance between an edge of the object-side surface and an edge of the sensor-side surface of the first lens 111. Accordingly, the first lens 111 can improve optical aberration or control incident light. The first surface S1 and the second surface S2 may be provided without a critical point from the optical axis to the end of the effective region.

The second lens 112 may have positive (+) or negative (−) refractive power on the optical axis OA, and for example, may have negative refractive power. The second lens 112 can include a plastic or glass material, and for example, may be a plastic material. The third surface S3 of the second lens 112 may have a convex shape on the optical axis OA, and the fourth surface S4 on the sensor side may have a concave shape on the optical axis OA. The second lens 112 may have a meniscus shape that is convex toward the object side on the optical axis OA. Alternatively, the third surface S3 may have a convex shape on the optical axis OA, and the fourth surface S4 may have a convex shape. That is, the second lens 112 may have a shape in which both sides are convex on the optical axis OA. Alternatively, the third surface S3 may have a concave shape on the optical axis OA, and the fourth surface S4 may have a convex shape on the optical axis OA. That is, the second lens 112 may have a convex meniscus shape toward the sensor in the optical axis OA. Alternatively, the third surface S3 may have a concave shape on the optical axis OA, and the fourth surface S4 may have a concave shape on the optical axis OA. That is, the second lens 112 may have a concave shape on the optical axis OA in both sides. At least one or both of the third surface S3 and the fourth surface S4 may be aspherical. The third surface S3 and the fourth surface S4 may be provided without a critical point from the optical axis to the end of the effective region.

The third lens 113 may have a refractive power opposite to that of the first lens 111 at the optical axis OA. That is, the third lens 113 may have negative (−) refractive power. The third lens 113 may include a plastic or glass material, and may be, for example, a plastic material. The object-side fifth surface S5 of the third lens 113 may have a concave shape on the optical axis OA, and the sensor-side sixth surface S6 may have a concave shape on the optical axis OA. That is, the third lens 113 may have concave shapes on both sides at the optical axis OA. Differently, the fifth surface S5 may have a convex shape on the optical axis OA, and the sixth surface S6 may have a concave shape on the optical axis OA. That is, the third lens 113 may have a convex meniscus shape from the optical axis OA to the object side. At least one or both of the fifth surface S5 and the sixth surface S6 may be aspherical. The fifth surface S5 and the sixth surface S6 may be provided without a critical point from the optical axis to the end of the effective region.

The object-side first lens 111 of the first lens group G1 may have a refractive power opposite to the refractive power of the sensor-side third lens 113. Accordingly, the plurality of lenses 111, 112, and 113 included in the first lens group G1 may mutually compensate for the chromatic aberration that occurs. The third lens 113 adjacent to the second lens group G2 in the first lens group G1 may have the highest refractive index within the first lens group G1. For example, the refractive index of the third lens 113 may be 1.6 or less. Accordingly, since the first lens group G1 controls the dispersion of light provided to the second lens group G2, the lens size of the second lens group G2 may be reduced.

The fourth lens 114 may have positive (+) refractive power on the optical axis OA. The fourth lens 114 may include a plastic or glass material, for example, may be a glass mold material, and may have a refractive index of less than 1.6. The object-side seventh surface S7 of the fourth lens 114 may have a convex shape on the optical axis OA, and the sensor-side eighth surface S8 may have a convex shape on the optical axis OA. That is, the fourth lens 114 may have a shape in which both sides are convex on the optical axis OA. In contrast, the seventh surface S7 may be convex in the optical axis OA, and the eighth surface S8 may be concave in the optical axis OA. That is, the fourth lens 114 may have a meniscus shape that is convex toward the object from the optical axis OA. At least one or both of the seventh surface S7 and the eighth surface S8 may be aspherical. The seventh surface S7 and the eighth surface S8 may be provided without a critical point from the optical axis to the end of the effective region.

The fifth lens 115 may have positive (+) or negative (−) refractive power on the optical axis OA. The fifth lens 115 may have negative refractive power opposite to that of the fourth lens 114 in the optical axis OA. The fifth lens 115 may include a plastic or glass material, and may be, for example, a plastic material. The object-side ninth surface S9 of the fifth lens 115 may have a concave shape on the optical axis OA, and the sensor-side tenth surface S10 may have a convex shape on the optical axis OA. That is, the fifth lens 115 may have a meniscus shape that is convex from the optical axis OA to the sensor side. At least one of the ninth surface S9 and the tenth surface S10 may be aspherical. For example, both the ninth surface S9 and the tenth surface S10 may be aspherical. The ninth surface S9 of the fifth lens 115 may be provided without at least one critical point. As another example, the ninth surface S9 of the fifth lens 115 may have a convex shape on the optical axis OA, and the tenth surface S10 may have a convex shape on the optical axis OA. That is, the fifth lens 115 may have a shape in which both sides are convex on the optical axis OA. Differently, the ninth surface S9 may have a concave shape on the optical axis OA, and the tenth surface S10 may have a concave shape on the optical axis OA. Differently, the ninth surface S9 may have a convex shape on the optical axis OA, and the tenth surface S10 may have a concave shape on the optical axis OA.

The fourth lens 114 has a convex shape on both sides, and the center thickness CT4 of the fourth lens 114 may be thicker than the edge thickness ET4, for example, may be twice or more. Accordingly, the gap between the fourth lens 114 and the fifth lens 115 may be reduced. The difference in Abbe number between the fourth lens 114 and the fifth lens 115 may be greater than 20 or greater than 30, and may be at most 60 or less. Accordingly, the second lens group G2 may minimize the change in chromatic aberration caused by the position changing according to the change in the operation mode.

The sixth lens 116 may have positive (+) or negative (−) refractive power on the optical axis OA, and may have negative refractive power, for example. The sixth lens 116 may include a plastic or glass material, and may be made of a plastic material, for example. The object-side eleventh surface S11 of the sixth lens 116 may have a concave shape on the optical axis OA, and the sensor-side twelfth surface S12 may have a concave shape on the optical axis OA. That is, the sixth lens 116 may have a shape in which both sides are concave on the optical axis OA. Alternatively, the eleventh surface S11 may have a convex shape on the optical axis OA, and the twelfth surface S12 may have a convex shape on the optical axis OA. That is, the sixth lens 116 may have a shape in which both sides are convex on the optical axis OA. Alternatively, the eleventh surface S11 may have a concave shape on the optical axis OA, and the twelfth surface S12 may have a convex shape on the optical axis OA. Alternatively, the eleventh surface S11 may have a convex shape on the optical axis OA, and the twelfth surface S12 may have a concave shape on the optical axis OA. At least one or both of the eleventh surface S11 and the twelfth surface S12 of the sixth lens 116 may be aspherical. The eleventh surface S11 and the twelfth surface S12 may be provided without a critical point from the optical axis to the end of the effective region.

The seventh lens 117 may have positive (+) or negative (−) refractive power on the optical axis OA, and may have positive refractive power. The seventh lens 117 has refractive power opposite to that of the sixth lens 116 on the optical axis OA, so as to improve chromatic aberration. The seventh lens 117 can include a plastic or glass material, and can be, for example, a plastic material. The object-side thirteenth surface S13 of the seventh lens 117 may have a convex shape on the optical axis OA, and the sensor-side fourteenth surface S14 may have a convex shape on the optical axis OA. That is, the above seventh lens 117 may have a convex shape on both sides on the optical axis OA. As another example, the thirteenth surface S13 may have a convex shape on the optical axis OA, and the fourteenth surface S14 may have a convex shape on the optical axis OA. That is, the seventh lens 117 may have a shape in which both sides are convex on the optical axis OA. Alternatively, the thirteenth surface S13 may have a concave shape on the optical axis OA, and the fourteenth surface S14 may have a convex shape on the optical axis OA. That is, the seventh lens 117 may have a meniscus shape that is convex toward the sensor in the optical axis OA. Alternatively, the thirteenth surface S13 may have a concave shape on the optical axis OA, and the fourteenth surface S14 may have a concave shape on the optical axis OA. That is, the seventh lens 117 may have a shape in which both sides are concave on the optical axis OA. At least one or both of the thirteenth surface S13 and the fourteenth surface S14 may be aspherical. The thirteenth surface S13 and the fourteenth surface S14 of the seventh lens 117 may be provided without a critical point from the optical axis to the end of the effective region. The sixth lens 116 and the seventh lens 117 have opposite refractive powers, and the Abbe number difference is set to 10 or less, so as to control chromatic aberration. Accordingly, the third lens group G3 may minimize chromatic aberration change caused by a position that changes according to a mode change and may perform an achromatic role.

The eighth lens 118 may have a negative (−) refractive power on the optical axis OA. The eighth lens 118 may include a plastic or glass material, and may be, for example, a plastic material. The object-side fifteenth surface S15 of the eighth lens 118 may have a convex shape on the optical axis OA, and the sensor-side sixteenth surface S16 may have a concave shape on the optical axis OA. That is, the eighth lens 118 may have a convex meniscus shape on the optical axis OA toward the object side. Alternatively, the eighth lens 118 may have a concave shape on the optical axis OA, and the sixteenth surface S16 may have a convex shape on the optical axis OA. That is, the eighth lens 118 may have a convex meniscus shape on the optical axis OA toward the sensor side. At least one or both of the fifteenth surface S15 and the sixteenth surface S16 may be aspherical.

At least one of the fifteenth surface S15 on the object side and the sixteenth surface S16 on the sensor side of the eighth lens 118 may have a critical point, for example, the fifteenth surface S15 may be provided without a critical point, and the sixteenth surface S16 may have a critical point. The critical point is a point where the sign of the gradient value with respect to the optical axis OA and the direction perpendicular to the optical axis OA changes from positive (+) to negative (−) or from negative (−) to positive (+), and may mean a point where the gradient value is 0. In addition, the critical point may be a point where the gradient value of the tangent passing through the lens surface increases and then decreases, or a point where it decreases and then increases. The center thickness CT8 of the eighth lens 118 may be thinner than the edge thickness ET8. Accordingly, the light distribution may be uniformly provided to the periphery of the image sensor 300 by the difference between the center thickness and the edge thickness of the eighth lens 118.

The third lens group G3 may be closest to the image sensor 300 among the plurality of lens groups G1, G2 and G3. The third lens group G3 can move in the optical axis direction, and the optical axis distance (BFL) between the eighth lens 118 and the image sensor 300 can vary depending on the operation mode. The third lens group G3 can play a role in controlling the chief ray angle (CRA). In detail, the CRA of the optical system 1000 according to the embodiment may be less than about 15 degrees, and the eighth lens 118 of the third lens group G3 may correct the principal CRA of light incident on the image sensor 300 according to each operation mode.

The camera module according to the second embodiment of the invention may include the optical system 1000 described above. The camera module may move the second and third lens groups G2 and G3 among the plurality of lens groups G1, G2 and G3 included in the optical system 1000 in the direction of the optical axis OA. The camera module may include a driving member (not shown) connected to the optical system 1000. The driving member is arranged on the outside of the second lens group G2 and the outside of the third lens group G3, and may move in the direction of the optical axis OA according to the operation mode.

The operation mode may include a first mode moving at a first magnification, and a third mode operating at a second magnification different from the first magnification. In this case, the second magnification may be greater than the first magnification. In addition, the operation mode may include a second mode having a magnification between the first and third modes. Here, the first magnification may be the lowest magnification of the optical system 1000, and the second magnification may be the highest magnification of the optical system 1000. The first magnification may be about 2.5 to about 5 magnifications, the second magnification may be about 6 to about 11 magnifications, and the third magnification may be about 4 to about 6 magnifications between the first and second magnifications. The first mode may be a wide mode, the second mode may be a middle mode, and the third mode may be a tele mode.

The driving member can move the second and third lens groups G2 and G3 or operate them in an initial mode according to one operation mode selected from the first to third modes. In detail, each of the plurality of driving members is connected to the second lens group G2 or the third lens group G3 and can move the second lens group G2 or the third lens group G3 according to the operation mode. The initial mode may be any one of the first, second, and third modes, and can be, for example, the second mode or the middle mode. For example, in the first mode, each of the second lens group G2 and the third lens group G3 may be positioned at a position defined as a first position (Position 1). In the second mode, each of the second lens group G2 and the third lens group G3 may be positioned at a second position (Position 2) defined closer to the object than the first position. In the third mode, each of the second lens group G2 and the third lens group G3 may be positioned at a third position (Position 3) defined as being closer to the sensor side than the first position. The first position may be a region between the second and third positions.

The first position at which the second lens group G2 is positioned in the first mode may be a region between the second and third positions at which the second lens group G2 is positioned in the second and third modes. The first position at which the third lens group G3 is positioned in the first mode may be a region between the second and third positions at which the third lens group G3 is positioned in the second and third modes.

The optical system 1000 according to the second embodiment may be such that the second lens group G2 and the third lens group G3 may move depending on the operation mode, and the first lens group G1 may be positioned at a fixed position. Depending on the operation mode, the second lens group G2 or the third lens group G3 may be moved, and the first lens group G1 may be arranged at a fixed position. In each of the first position, the second position, and the third position according to the operation mode, the first to third lens groups G1, G2 and G3 may have a set interval from the adjacent lens groups. Accordingly, the optical system 1000 may have a constant TTL (Total track length) and a variable BFL depending on the operation mode, and the effective focal length and magnification of the optical system 1000 may be controlled by controlling the positions of some lens groups.

The effective diameter of the first lens 111 is the largest among the lenses, and the effective diameter of the sixth lens 116 is the smallest among the lenses. The Abbe number of the fourth lens 114 may be the largest among the lenses, and may be 60 or more. In the absolute value of the focal length, the focal length of the second lens 112 may be the largest among the lenses, and the difference (absolute value) of the focal length between adjacent two lenses may be the largest between the second and third lenses 112 and 113, and the smallest between the sixth and seventh lenses 116 and 117.

The optical axis distance DG12 between the first lens group G1 and the second lens group G2, and the optical axis distance DG23 between the second lens group G2 and the third lens group G3 may be at least 0.2 mm or more and at most 8 mm or less, depending on the operation mode. Depending on the operation mode, the F number of the optical system 1000 may provide a brightness of 2.0 or more, and the F number may be in the range of 2.2 to 3.8. The aperture stop may be located between the first lens group G1 and the second lens group G2.

The optical system 1000 according to the second embodiment can satisfy at least one or two or more of the mathematical equations described below. Accordingly, the optical system 1000 according to the embodiment can effectively correct aberrations that change according to a change in the operation mode. In addition, the optical system 1000 according to the embodiment can effectively provide an autofocus (AF) function for a subject at various magnifications and may have a slim and compact structure. Hereinafter, the center thickness of the first to eighth lenses 111-118 may be defined as CT1-CT8, the edge thickness may be defined as ET1-ET8, and the optical axis distance between adjacent two lenses may be defined as CG1-CG7 from the distance between the first and second lenses to the distance between the seventh and eighth lenses. The average effective diameters of the object-side and sensor-side surfaces of the first to eighth lenses 111-118 may be defined as CA1-CA8, and the effective diameters of the object-side and sensor-side surfaces of the first lens 111 to the object-side and sensor-side surfaces of the eighth lens 118 may be defined as CA11, CA12 to CA81, CA82. The units of the thickness, interval, and effective diameter values are mm. In addition, the effective diameter is when the lens is a circular or partially circular shape, and may be defined as the effective diameter or the maximum diameter when the lens is a partially circular shape.

$$n\_G1 , n\_G2 , n\_G3 > 1 \qquad [ Equation 1 ]$$

$$( n\_G1 , n\_G2 , n\_G3 are natural numbers )$$

In Equation 1, n_G1, n_G2, n_G3 represent the number of lenses included in each of the first to third lens groups G1, G2 and G3. Here, it may have the relationship of n_G1>n_G2, n_G3>n_G2.

$$0.7 < CA 41 / CA 11 < 1.2 \qquad [ Equation 2 ]$$

In Equation 2, CA41 is the maximum effective diameter of the seventh surface S7 of the fourth lens 114, and CA11 is the maximum effective diameter of the first surface S1 of the first lens 111. If Equation 2 is satisfied, a high EPD (Entrance pupil diameter) compared to the optical system may be provided.

$$2 < CT 1 / CT 3 < 5 \qquad [ Equation 3 ]$$

In Equation 3, CT1 is the thickness (mm) of the first lens 111 in the optical axis, and CT3 is the thickness of the third lens 113 on the optical axis. If Equation 3 is satisfied, aberration characteristics in the optical system 1000 may be improved. Preferably, 2.5<CT1/CT3<4 may be satisfied.

$$0 < CT 1 / CT 4 < 1 \qquad [ Equation 4 ]$$

In Equation 4, CT3 means the thickness (mm) of the fourth lens 114 in the optical axis OA. When the optical system 1000 according to the embodiment satisfies Equation 4, the optical system 1000 can improve the aberration characteristics. Preferably, 0.5<CT1/CT4<0.85 may be satisfied.

$$1.2 < ET 3 / CT 3 < 3.2 \qquad [ Equation 5 ]$$

In Equation 4, ET3 means the thickness (mm) in the optical axis OA direction at the edge, which is the end of the effective region of the third lens 113. When the optical system 1000 according to the embodiment satisfies Equation 5, the optical system 1000 can improve the distortion characteristics.

$$GIF < 0 \qquad [ Equation 6 ]$$

In Equation 6, GIF is the effective focal length (EFL) of the first lens group G1, and may have a value less than 0. It is the composite focal length of the first to third lenses. When Equation 6 is satisfied, the optical aberration of the optical system or the optical aberration of the first lens group G1 may be improved.

$$CRA < 20 degrees \qquad [ Equation 7 ]$$

In Equation 7, CRA (Chief ray angle) is the chief ray incident angle, and the incident angle of the chief ray in the optical system may be less than 20 degrees at most, and may be 15 degrees or less, for example. The first mode may be a wide mode, the second mode may be a middle mode, and the third mode may be a tele mode. Here, in the case of the first mode (Wide), the principal ray incident angle may be greater than the principal ray incident angle in the case of the second mode at 1.0 field. In the case of the third mode (Tele), the principal ray incident angle may be 11 degrees or less at 1.0 field, and the principal ray incident angle of the second mode may be smaller than the principal ray incident angle of the first mode. When Equation 6 is satisfied, the peripheral light ratio may be secured.

$$( TTL / DG 1 ) > 3.5 \qquad [ Equation 8 ]$$

In Equation 8, DG1 is the optical axis distance of the first lens group G1, and for example, the optical axis distance from the center of the object-side surface of the first lens 111 to the center of the sensor-side surface of the third lens 113. For example, the DG1 means the distance (mm) from the optical axis OA of the first surface S1 of the first lens 111 and the sixth surface S6 of the third lens 113. The TTL (Total track length) means the distance (mm) from the optical axis OA from the object-side first surface S1 of the first lens 111 to the imaging surface of the image sensor 300. When the optical system 1000 according to the embodiment satisfies Equation 8, the optical system 1000 has a relatively small TTL and can secure a peripheral light ratio.

$$2 < TTL / EPD 3 < 7 \qquad [ Equation 9 ]$$

In Equation 9, EPD3 means the size of the EPD of the optical system 1000 when operating in the third mode, i.e., Tele mode. When the optical system 1000 according to the embodiment satisfies the Equation 9, the optical system 1000 can secure a bright image when operating in the third mode, and may be a minimum condition for securing an F number of 4 or less in the tele mode. Preferably, 3<TTL/EPD3<5 may be satisfied.

$$3 < TTL / EPD 1 < 7 \qquad [ Equation 9 - 1 ]$$

$$2 < TTL / EPD 2 < 6 \qquad [ Equation 9 - 2 ]$$

$$( TTL / EPD 3 ) < ( TTL / EPD 2 ) < ( TTL / EPD 1 ) \qquad [ Equation 9 - 3 ]$$

In Equations 9-1 to 9-3, EPD1 is the size of the EPD of the optical system in the first mode (Wide), and EPD2 is the size of the EPD of the optical system in the second mode (Middle). When the optical system satisfies the above condition, it can secure a bright image according to each mode.

$$2 < CT\_Max / CT\_Min < 6 \qquad [ Equation 10 ]$$

In Equation 10, CT_Max is the thickest thickness among the center thicknesses of the lenses, and CT_Min is the thinnest thickness among the center thicknesses of the lenses, and when Equation 10 is satisfied, the optical system aberration characteristics may be improved. Preferably, 3<CT_Max/CT_Min<5.5 may be satisfied.

$$1 < CA\_Max / CA\_Min < 3 \qquad [ Equation 11 ]$$

In Equation 11, CA_Max is the largest effective diameter among the lenses, and CA_Min is the smallest effective diameter among the lenses, and when Equation 11 is satisfied, the optical performance of the optical system may be maintained, and a camera module for a slim or compact structure may be provided.

$$0.1 < Σ CG\_Wide / TTL < 0.6 \qquad [ Equation 12 ]$$

In Equation 12, ΣCG_Wide is the sum of the central distances between adjacent lenses in the first mode. When the optical system satisfies Equation 12, the center distance DG12 between the first and second lens groups and the center distance between the second and third lens groups may be set according to the wide mode. The center distance DG12 between the first and second lens groups may be the center distance CG3 between the third and fourth lenses 113 and 114 and varies depending on the operation mode. The center distance DG23 between the second and third lens groups is the center distance CG5 between the fifth and sixth lenses 115 and 116 and varies depending on the operation mode.

$$0.05 < ΣCG\_Mid / TTL < 0.4 \qquad [ Equation 12 - 1 ]$$

$$0 < ΣCG\_Tele / TTL < 0.3 \qquad [ Equation 12 - 2 ]$$

In Equations 12-1 and 12-2, ΣCG_Mid is the sum of the center distances between adjacent lenses in the second mode, and ΣCG_Tele is the sum of the center distances between adjacent lenses in the third mode. When the optical system satisfies Equations 12-1 and 12-2, the center distance DG12 between the first and second lens groups and the center distance between the second and third lens groups may be set according to the middle mode and the tele mode. When the optical system 1000 satisfies at least one or two or more of Equations 1 to 12, the optical system 1000 may have a slim structure. In addition, the optical system 1000 may have improved assemblability and a mechanically stable form.

$$0.5 < DG 1 / DG 2 < 3 \qquad [ Equation 13 ]$$

In Equation 13, DG1 is the optical axis distance of the first lens group G1, and means, for example, the optical axis distance between the first surface S1 of the first lens 111 and the sixth surface S6 of the third lens 113. DG2 is the optical axis distance of the second lens group G2, and means, for example, the optical axis distance between the seventh surface S7 of the fourth lens 114 and the tenth surface S10 of the fifth lens 115. By setting the optical axis distances of the first and second lens groups G1 and G2 in Equation 13, TTL may be adjusted. Preferably, 0.8<DG1/DG2<1.5 may be satisfied.

$$0 \text{.5} < DG 2 / DG 3 < 2 \qquad [ Equation 14 ]$$

In Equation 14, DG2 means the optical axis distance of the second lens group G2, for example, the optical axis distance between the seventh surface S7 of the fourth lens 114 and the tenth surface S10 of the fifth lens 115. DG3 means the optical axis distance of the third lens group G3, for example, the optical axis distance between the eleventh surface S11 of the sixth lens 116 and the sixteenth surface S16 of the eighth lens 118. Preferably, 0.5<DG2/DG3<1 may be satisfied. When the optical system 1000 according to the embodiment satisfies at least one of Equations 13 and 14, it has a relatively small TTL and can provide various magnifications according to at least three mode changes.

$$0 < CG 2 / TTL < 0.2 \qquad [ Equation 15 ]$$

In Equation 15, CG2 is the optical axis distance between the second lens 112 and the third lens 113. When the optical system 1000 satisfies Equation 15, the optical system 1000 has a relatively small TTL and may have improved optical characteristics by controlling stray light incident on the first lens group G1. Preferably, 0<CG2/TTL<0.1 may be satisfied.

$$3 < TTL / DG 2 < 10 \qquad [ Equation 16 ]$$

In Equation 16, DG2 is the optical axis distance of the second lens group G2. When the optical system 1000 according to the embodiment satisfies Equation 16, the optical system 1000 has a relatively small TTL and can improve chromatic aberration characteristics.

$$20 < IVd 4 - Vd 5 I < 70 \qquad [ Equation 17 ]$$

In Equation 17, Vd4 means the Abbe Number of the fourth lens 114, and Vd5 means the Abbe Number of the fifth lens 115. If the absolute value of the difference in Abbe numbers between the fourth and fifth lenses of the optical system 1000 according to the embodiment satisfies Equation 17, the optical system 1000 can improve chromatic aberration characteristics.

$$15 < IVd 8 - Vd 7 I < 60 \qquad [ Equation 18 ]$$

In Equation 18, Vd8 means the Abbe Number of the eighth lens, and Vd7 means the Abbe Number of the seventh lens. If the absolute value of the difference in Abbe numbers between the seventh and eighth lenses satisfies Equation 18, the optical system 1000 can improve chromatic aberration characteristics.

$$1.6 < n 1 \qquad [ Equation 19 ]$$

In Equation 19, n1 means the refractive index of the d-line of the first lens 111. When the optical system 1000 according to the embodiment satisfies Equation 19, the incident light may be dispersed, and the effective region of the lens arranged after the first lens 111 may be secured. The refractive indices of the fourth and eighth lenses 114 and 118 may be less than 1.6, and the refractive index of the fourth lens 114 may be the smallest among the lenses. Among the lenses, the number of lenses having a refractive index of 1.63 or higher is 2 or more.

$$1 < L 1 R 1 / L 3 R 2 < 2.5 \qquad [ Equation 20 ]$$

In Equation 20, L1R1 means the radius of curvature of the object-side first surface S1 of the first lens 111, and L3R2 means the radius of curvature of the sensor-side sixth surface S6 of the third lens 113. When the optical system 1000 according to the embodiment satisfies Equation 20, the optical system 1000 can control stray light incident on the first lens group G1.

$$1.5 < L 1 R 1 / L 4 R 1 < 3.5 \qquad [ Equation 21 ]$$

In Equation 21, L1R1 means the radius of curvature of the object-side first surface S1 of the first lens 111, and L4R1 means the radius of curvature of the object-side seventh surface S7 of the fourth lens 114. When the optical system 1000 according to the embodiment satisfies Equation 21, the optical system 1000 may have good optical performance at various magnifications.

$$0 < L 3 R 2 / L 4 R 1 < 2 \qquad [ Equation 22 ]$$

In Equation 22, L3R2 means the radius of curvature of the sensor-side sixth surface S6 of the third lens 113, and L4R1 means the radius of curvature of the object-side seventh surface S7 of the fourth lens 114. When the optical system 1000 according to the embodiment satisfies the Equation 22, the optical system 1000 may have good optical performance in the periphery portion of the FOV when operating at various magnifications of at least three modes.

$$1 < L 1 R 1 / L 8 R 2 < 3 \qquad [ Equation 23 ]$$

In Equation 23, L1R1 means the radius of curvature of the object-side first surface S1 of the first lens 111, and L8R2 means the radius of curvature of the sensor-side sixteenth surface S16 of the eighth lens 118. When the optical system 1000 according to the embodiment satisfies the Equation 23, the optical system 1000 may have good optical performance in the center and periphery portions of the FOV.

$$0 < Mode12\_ mG 2 / TTL < 0.5 \qquad [ Equation 24 ]$$

In Equation 24, Mode12_mG2 means the difference (unit: mm) in the center distance after the movement of the second lens group G2 when changing from the second mode to the first mode or from the first mode to the second mode. In detail, the Mode12_mG2 represents the movement distance of the second lens group G2 in the first and second modes, and means the difference value between the optical axis distance between the first and second lens groups G1 and G2 in the first mode and the optical axis distance between the first and second lens groups G1 and G2 in the second mode. When the optical system 1000 according to the embodiment satisfies Equation 24, the optical system 1000 can minimize the movement distance of the second lens group G2 when the magnification is changed, so that the optical system 1000 may have a slim structure. In addition, since the movement distance may be minimized when controlling the position of the second lens group G2, improved power consumption characteristics may be achieved.

$$0 < Mode23\_ mG 2 / TTL < 0.5 \qquad [ Equation 25 ]$$

In Equation 25, Mode23_mG2 means the difference (unit: mm) in the center distance after the movement of the second lens group G2 when operating from the second mode to the third mode, or from the third mode to the second mode. In detail, Mode23_mG2 means the difference value between the optical axis distance between the first and second lens groups G1 and G2 in the second mode and the optical axis distance between the first and second lens groups G1 and G2 in the third mode. The maximum movement distance of the second lens group G2 may be greater than the maximum movement distance of the third lens group G3. When the optical system 1000 according to the embodiment satisfies the Equation 25, the optical system 1000 can minimize the movement distance of the second lens group G2 when the magnification is changed, so that the optical system 1000 may have a slim structure. In addition, since the movement distance may be minimized when the position of the second lens group G2 is controlled, it may have improved power consumption characteristics.

$$0.3 < Mode12\_ mG 2 / DG 2 < 1 \qquad [ Equation 26 ]$$

Equation 26 means the difference in the center distance after the movement of the second lens group G2 when Mode12_mG2 operates from the first mode to the second mode, or from the second mode to the first mode. When the optical system 1000 according to the embodiment satisfies Equation 26, the optical system 1000 can minimize the movement distance of the second lens group G2 when the magnification is changed, so that the optical system 1000 may have a slim structure. In addition, the movement distance may be minimized when the position of the second lens group G2 is controlled, so that the optical system 1000 may have improved power consumption characteristics. DG2 is the optical axis distance of the second lens group G2. When the optical system 1000 according to the embodiment satisfies Equation 26, the optical system 1000 can minimize the movement distance of the second lens group G2 when the magnification is changed, so that the optical system 1000 may have a slim structure. In addition, the movement distance may be minimized when the position of the second lens group G2 is controlled, so that the optical system 1000 may have improved power consumption characteristics.

$$0 < Mode23\_ mG 3 / DG 3 < 0.5 \qquad [ Equation 27 ]$$

In Equation 27, Mode23_mG3 means the difference in the center distance after the movement of the third lens group G3 when changing from the second mode to the third mode or from the third mode to the second mode. DG3 is the optical axis distance of the third lens group G3. When the optical system 1000 according to the embodiment satisfies Equation 27, the optical system 1000 can minimize the movement distance of the third lens group G3 when the magnification is changed, so that the optical system 1000 may have a slim structure. In addition, since the movement distance may be minimized when controlling the position of the third lens group G3, it may have improved power consumption characteristics.

$$1 < ( CT 1 / ET 1 ) / ( CT 3 / ET 3 ) < 5 \qquad [ Equation 28 ]$$

In Equation 28, CT1/ET1 is a value obtained by dividing the thickness of the optical axis of the first lens 111 by the thickness at the end, and CT3/ET3 is a value obtained by dividing the thickness of the optical axis of the third lens 113 by the thickness at the end. If the value obtained by dividing the center thickness and the end thickness of the first and third lenses 111 and 113 satisfies Equation 28 at the above ratio, chromatic aberration may be improved and incident light may be controlled.

$$0.5 < ( CT 1 / ET 1 ) / ( CT 7 / ET 7 ) < 1.5 \qquad [ Equation 29 ]$$

In Equation 29, CT1/ET1 is a value obtained by dividing the thickness of the optical axis of the seventh lens 117 by the thickness at the end. If the values obtained by dividing the center thickness and the end thickness of the first and seventh lenses 111 and 117 satisfy the Equation 29 with the above ratio, chromatic aberration may be improved and incident light may be controlled.

$$1 < Mode 1 ( DG 12 / DG 23 ) < 5 \qquad [ Equation 30 ]$$

In Equation 30, Model (DG12/DG23) represents the ratio between the center distance DG12 between the first and second lens groups in the first mode and the center distance DG23 between the second and third lens groups. If the optical system 1000 according to the embodiment satisfies Equation 30, the optical system 1000 may have improved optical characteristics at the first magnification. In detail, the optical system 1000 may have improved aberration characteristics at the first magnification and can improve optical performance at the center and periphery portions of the FOV.

$$0 < Mode 3 ( DG 12 / DG 23 ) < 0.7 \qquad [ Equation 31 ]$$

In Equation 31, Mode3 (DG12/DG23) represents the ratio between the center distance DG12 between the first and second lens groups in the third mode and the center distance DG23 between the second and third lens groups. When the optical system 1000 according to the embodiment satisfies Equation 31, the optical system 1000 may have improved optical characteristics at the second magnification. In detail, the optical system 1000 may have improved aberration characteristics at the second magnification and may improve optical performance at the periphery portion of the FOV.

$$0.5 < TD 2 / TTL < 1 \qquad [ Equation 32 ]$$

In Equation 32, TD2 is the optical axis distance from the center of the object-side surface of the first lens to the center of the sensor-side surface of the eighth lens in the second mode. When the optical system 1000 according to the embodiment satisfies Equation 32, the optical system 1000 may have improved optical characteristics in the middle mode. In detail, the optical system 1000 may have improved aberration characteristics in the middle mode and can improve optical performance in the peripheral portion of the FOV.

$$1 < TD 1 / TD 2 < 1.5 \qquad [ Equation 33 ]$$

In Equation 33, TD1 is the optical axis distance from the center of the object-side surface of the first lens to the center of the sensor-side surface of the eighth lens in the first mode. When the optical system 1000 according to the embodiment satisfies Equation 33, the optical system 1000 may have improved optical characteristics in the first and second modes. In detail, the optical system 1000 may have improved aberration characteristics in the first and second modes and can improve optical performance in the peripheral portion of the FOV.

$$10 mm < TD 3 < TD 2 < TD 1 < 20 mm \qquad [ Equation 34 ]$$

Equation 34 is a drawing comparing the optical axis distances of lenses in the first, second, and third modes, and TD3 is the optical axis distance from the center of the object-side surface of the first lens to the center of the sensor-side surface of the eighth lens in the third mode. When the optical system 1000 according to the embodiment satisfies Equation 34, the optical system 1000 may have improved optical characteristics in the first, second, and third modes. In detail, the optical system 1000 may have improved aberration characteristics in the first, second, and third modes and improve the optical performance of the peripheral portion of the FOV.

$$0.5 < BFL 2 / TTL < 1 \qquad [ Equation 35 ]$$

In Equation 35, BFL2 (Back focal length 2) is the optical axis distance from the center of the sensor-side surface of the eighth lens to the imaging surface of the image sensor in the second mode. When the optical system 1000 according to the embodiment satisfies Equation 35, the optical system 1000 can adjust the focus position toward the imaging surface of the image sensor 300 in the second mode. In detail, the optical system 1000 has improved optical characteristics in the second mode and can improve the optical performance of the peripheral portion of the FOV.

$$2 < BFL 3 / BFL 1 < 4 \qquad [ Equation 36 ]$$

In Equation 36, BFL3 is the optical axis distance from the center of the sensor-side surface of the eighth lens to the imaging surface of the image sensor in the third mode. When the optical system 1000 according to the embodiment satisfies Equation 36, the optical system 1000 can adjust the focus position toward the imaging surface of the image sensor 300 in the first and third modes. In detail, the optical system 1000 has improved optical characteristics in the first and third modes and can improve the optical performance of the peripheral portion of the FOV.

$$1.5 < TD 3 / BFL 3 < 3 \qquad [ Equation 37 ]$$

Equation 37 is a value comparing the optical axis distance (TD3) between the center of the object-side surface of the first lens and the center of the sensor-side surface of the eighth lens in the third mode, and the optical axis distance (BFL3) from the center of the sensor-side surface of the eighth lens 118 to the imaging surface of the image sensor. When the optical system 1000 according to the embodiment satisfies Equation 37, the optical system 1000 may have improved optical characteristics in the third mode. In detail, the optical system 1000 may have improved aberration characteristics in the third mode and may improve optical performance in the periphery portion of the FOV.

$$2 < Mode\_CG \_Max / Mode\_CG \_Min < 8 \qquad [ Equation 38 ]$$

In Equation 38, Mode_CG_Max means the maximum center distance among the center distances between the first to eighth lenses in the first, second, and third modes, and Mode_CG_Min means the minimum center distance among the center distances between the first to eighth lenses in the first, second, and third modes. When the optical system satisfies Equation 38, the TTL and the optical axis distances of the lenses according to each mode may be adjusted.

$$1 < BFL 1 < 10 \qquad [ Equation 39 ]$$

Equation 39 represents the optical axis distance between the eighth lens and the image sensor in the first mode. When the optical system satisfies Equation 39, the focus position on the imaging surface of the image sensor in the first mode may be adjusted.

$$30 < Aver\_Abbe < 50 \qquad [ Equation 40 ]$$

In Equation 40, Aver_Abbe is the average of Abbe numbers of the first to eighth lenses. When the optical system satisfies Equation 40, the optical system 1000 may have improved aberration characteristics and resolution.

$$1.5 < Aver\_Index < 1.8 \qquad [ Equation 41 ]$$

In Equation 40, Aver_Index is the average of refractive indices of the first to eighth lenses. When the optical system satisfies Equation 41, the optical system 1000 may have improved aberration characteristics and resolution.

$$10 < \sum Abbe / \sum Index < 40 \qquad [ Equation 41 - 1 ]$$

In Equation 41-1, ΣAbbe means the sum of the Abbe numbers of each of the plurality of lenses. Index means the sum of the refractive indices of each of the plurality of lenses. When the optical system 1000 according to the embodiment satisfies Equation 41-1, the optical system 1000 may have improved aberration characteristics and resolution. Preferably, the following Equation 41-1 may satisfy: 15<ΣAbb/ΣIndex<25. Preferably, the following condition may satisfy: (ΣAbb−ΣIndex)<280.

$$2 < \vert G 1 F / G 2 F \vert < 4 \qquad [ Equation 42 ]$$

In Equation 42, GIF represents the EFL of the first lens group G1, and G2F represents the EFL of the second lens group G2. G2F is the composite focal length of the fourth and fifth lenses. If Equation 42 is satisfied, the size of the optical system, for example, the TTL, may be reduced. Preferably, G2F>0 is satisfied. G3F is the composite focal length of the sixth to eighth lenses, and G3F<0, and the following condition may satisfy: |G1F|>|G3F|>G2F.

$$1 < \vert M 2 F / M 1 F \vert < 10 \qquad [ Equation 43 ]$$

In Equation 43, MIF is the effective focal length of the optical system in the first mode, and M2F is the effective focal length of the optical system in the second mode. Preferably, 1<M2F/M1F<3 may be satisfied. When the optical system satisfies Equation 43, the effective focal length may be adjusted according to the first and second modes.

$$1 < M 3 F / M 2 F < 10 \qquad [ Equation 43 - 1 ]$$

In Equation 43, M3F is the effective focal length of the optical system in the third mode. Preferably, 1<M3F/M2F<3 may be satisfied, and the following condition may satisfy: (M3F/M1 F)> (M3F/M2 F). When the optical system satisfies Equation 43-1, the effective focal length may be adjusted according to the second and third modes.

$$2 < M 2 F / EPD 2 < 7 \qquad [ Equation 44 ]$$

In Equation 44, M2F is the effective focal length of the optical system in the second mode (Middle), and EPD2 means the size of the EPD of the optical system 1000 in the second mode. When the optical system 1000 according to the embodiment satisfies Equation 44, the optical system 1000 can secure a bright image when operating in the second mode.

$$0.1 < M 1 F / EPD 1 < 3 \qquad [ Equation 45 ]$$

In Equation 34, MIF is the effective focal length of the optical system in the first mode (Wide), and EPD1 means the size of the EPD of the optical system 1000 when operating in the first mode. When the optical system 1000 according to the embodiment satisfies the Equation 45, the optical system 1000 can secure a bright image when the first mode is operated.

$$M 1 F < M 2 F < M 3 F \qquad [ Equation 46 ]$$

In Equation 46, MIF, M2F, and M3F represent the effective focal lengths of the optical system in the first, second, and third modes. The effective focal length in the third mode may be the largest, and the effective focal length in the first mode may be the smallest.

$$0 < TTL / M 2 F < 2 \qquad [ Equation 47 ]$$

Equation 47 can adjust the TTL by comparing the effective focal lengths in the TTL and second modes. Preferably, 1<TTL/M2F<2 may be satisfied.

$$0.1 < TTL / M 1 F < 5 \qquad [ Equation 48 ]$$

Equation 47 can adjust TTL by comparing the effective focal length in TTL and the first mode. Preferably, 1<TTL/M1F<4 may be satisfied.

$$1 < CA\_Max / ImgH < 3 \qquad [ Equation 49 ]$$

In Equation 49, CA_Max means the size (CA) of the largest effective diameter among the lens surfaces of the lens unit 100A included in the optical system 1000. ImgH is the distance from a region of the 0 field of the imaging surface center of the image sensor 300 overlapping with the optical axis OA to a region of the 1.0 field region of the image sensor 300. The ImgH means ½ of the maximum diagonal length of the effective region of the image sensor 300. If the optical system 1000 according to the embodiment satisfies the Equation 49, the optical system 1000 may be provided in a slim and compact manner. In addition, the optical system 1000 can implement high resolution and high image quality. The range of the ImgH is 2 mm to 3 mm.

$$5 < TTL / ImgH < 12 \qquad [ Equation 50 ]$$

If the optical system 1000 satisfies the Equation 39, the optical system 1000 may have a smaller TTL, so that the optical system 1000 may be provided in a slim and compact manner. Preferably, the range may be 6<TTL/ImgH<10.

$$1 < BFL 2 / ImgH < 3 \qquad [ Equation 51 ]$$

If the optical system 1000 according to the embodiment satisfies Equation 51, the BFL required for a small image sensor of less than 1 inch may be secured. In addition, if the optical system 1000 satisfies Equation 51, the optical system 1000 can operate at various magnifications while maintaining TTL, and may have excellent optical characteristics at the center and periphery portions of the FOV. Preferably, it may be in the range of 2<BFL2/ImgH<3.

$$2 < BFL 3 / ImgH < 4 \qquad [ Equation 52 ]$$

If the optical system 1000 according to the embodiment satisfies Equation 52, the BFL required for a small image sensor of less than 1 inch may be secured. In addition, when the optical system 1000 satisfies the Equation 51, the optical system 1000 can operate at various magnifications while maintaining TTL, and may have excellent optical characteristics at the center and periphery portions of the FOV. Preferably, 2.5<BFL3/ImgH<3.5 may be satisfied.

$$1 < EPD 1 < EPD 2 < EPD 3 < 7 \qquad [ Equation 53 ]$$

In Equation 53, EPD1, EPD2, and EPD3 represent the sizes of the EPDs of the optical system according to the first to third modes, and can adjust the brightness according to each mode.

$$0 < Max\_Distortion < 3 \qquad [ Equation 54 ]$$

In Equation 54, distortion means the maximum value or maximum value of distortion from the center (0.0 F) of the image sensor to the diagonal end (1.0 F) based on the optical characteristics detected by the image sensor 300. When the optical system 1000 satisfies Equation 54, the optical system 1000 can improve the distortion characteristics and set conditions for image processing. Preferably, Distortion<1.5 may be satisfied.

$$8 < FOV 3 < FOV 2 < FOV 1 < 45 \qquad [ Equation 55 ]$$

In Equation 55, FOV1, FOV2, and FOV3 mean the diagonal field of view of the optical system in the first, second, and third modes. FOV means the field of view (Degree) in the diagonal direction of the optical system 1000, and can provide an optical system of less than 45 degrees.

The aspherical coefficient of the lenses of the optical system of the second embodiment refers to the Equation 56 of the first embodiment.

The optical system 1000 according to the second embodiment can satisfy at least one of the Equations 1 to 55 described above. Accordingly, the optical system 1000 and the camera module may have improved optical characteristics. In detail, since the optical system 1000 satisfies at least one or two or more Equations of the Equations 1 to 55 described above, the optical characteristics deterioration such as chromatic aberration, vignetting, diffraction effect, and deterioration of image quality in the periphery caused by movement of the lens group may be effectively corrected. And, the optical system 1000 according to the embodiment can significantly reduce the movement distance of the lens group and provide an autofocus (AF) function for various magnifications with excellent power consumption characteristics.

Since the optical system 1000 satisfies at least one or two of the Equations 1 to 55, it may have improved assembly properties and a mechanically stable shape, and is provided with a slim structure, so that the optical system 1000 and the camera module including it may have a compact structure.

Hereinafter, the optical system 1000 according to the second embodiment and the first to third mode changes will be described in more detail. The optical system 1000 may be fixed in the first lens group G1 and may be moved in accordance with the operation mode in the second lens group G2 and the third lens group G3. The first lens group G1 may include three lenses, for example, the first to third lenses 111, 112, and 113, and the second lens group G2 may include two lenses, for example, the fourth and fifth lenses 114 and 115. In addition, the third lens group G3 may include three lenses, for example, the sixth to eighth lenses 116, 117, and 118. In the optical system 1000 according to the embodiment, the object-side surface (the seventh surface S7) of the fourth lens 114 may function as an aperture stop, and the optical filter 500 described above may be arranged between the fourth lens group G4 and the image sensor 300.

FIG. 15 shows the radius of curvature of the optical axis OA of the first to eighth lenses 111-118, the center thickness CT of the lenses, the center distance CG between adjacent components, for example, the lenses, the refractive index at the d-line, the Abbe number, and the effective diameter (CA). In FIG. 15, the object-side surface and the sensor-side surface of the first to eighth lenses (Lens 1-8) are described as S1 and S2, DG12 is the optical axis distance between the third lens 103 and the fourth lens 104, and DG23 is the optical axis distance between the fifth lens 105 and the sixth lens 106. DG4 is the optical axis distance between the seventh lens and the optical filter 500, and may be varied according to the movement of the third lens group G3.

TABLE 6

| Lens groups | Lenses | CT/ET |
|---|---|---|
| First lens group | First lens | 1.306 |
| | Second lens | 0.974 |
| | Third lens | 0.492 |
| Second lens group | Fourth lens | 2.512 |
| | Fifth lens | 0.909 |
| Third lens group | Sixth lens | 0.757 |
| | Seventh lens | 1.365 |
| | Eighth lens | 0.478 |

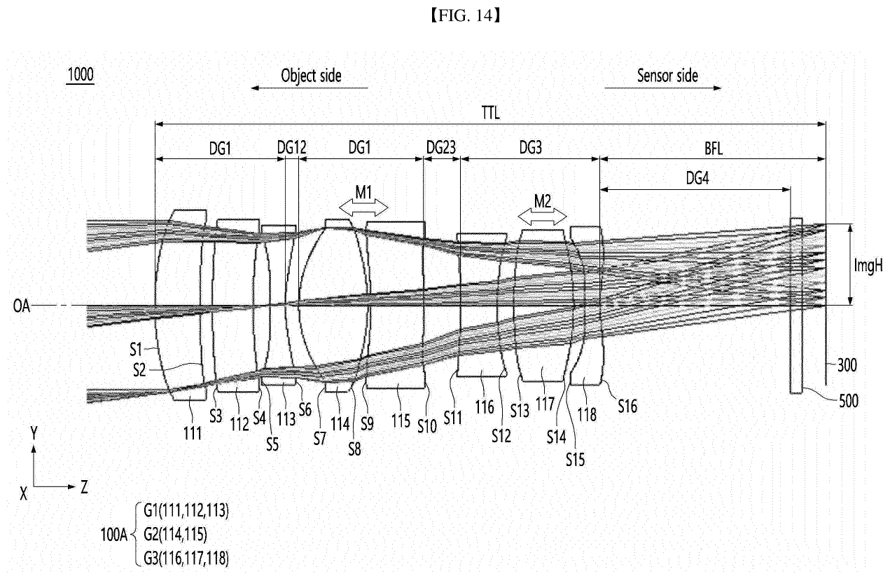

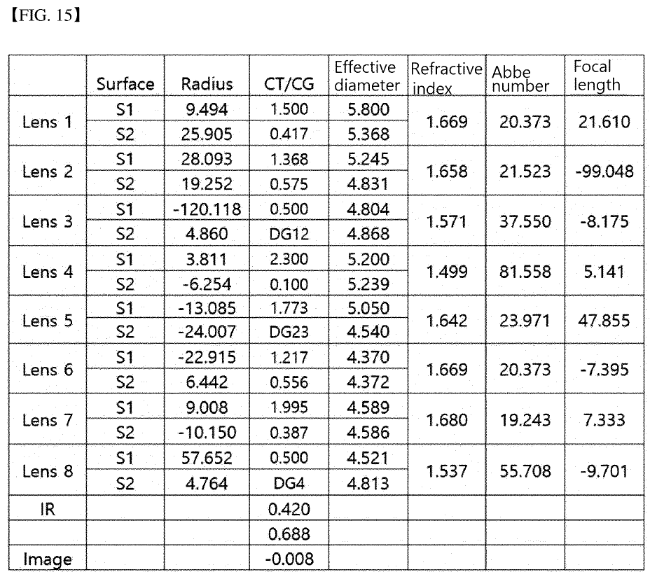

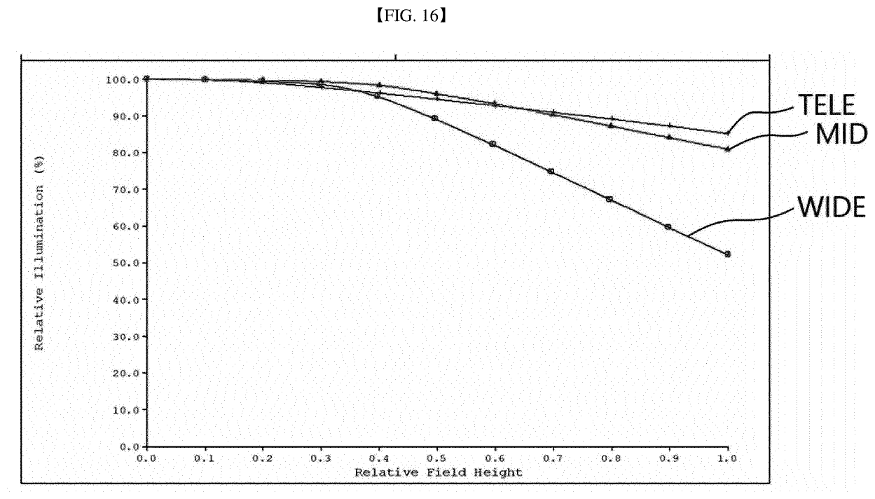

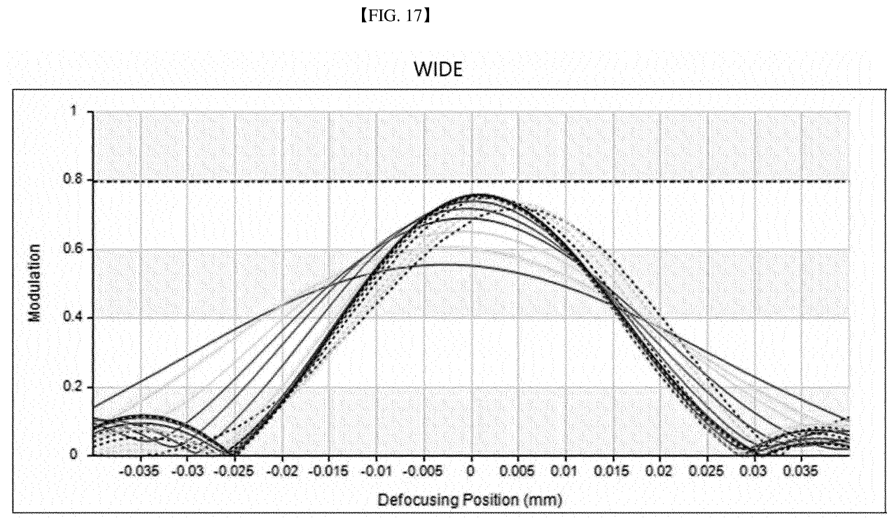

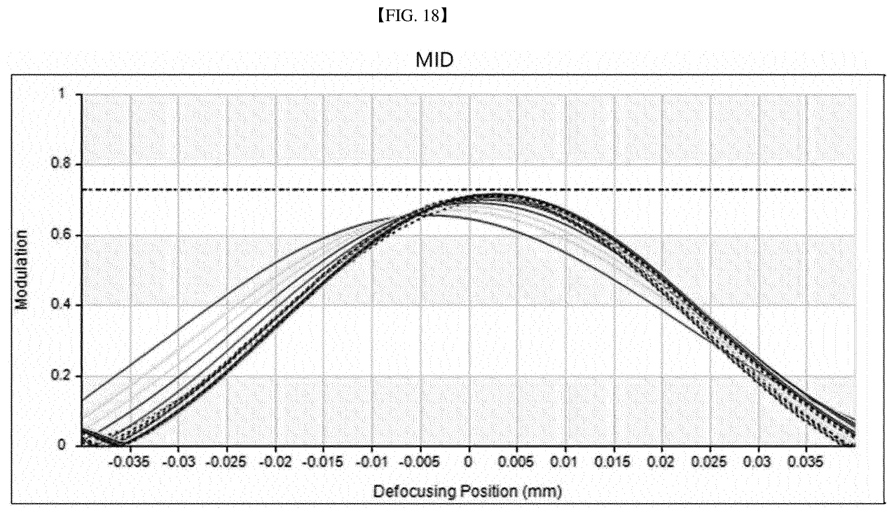

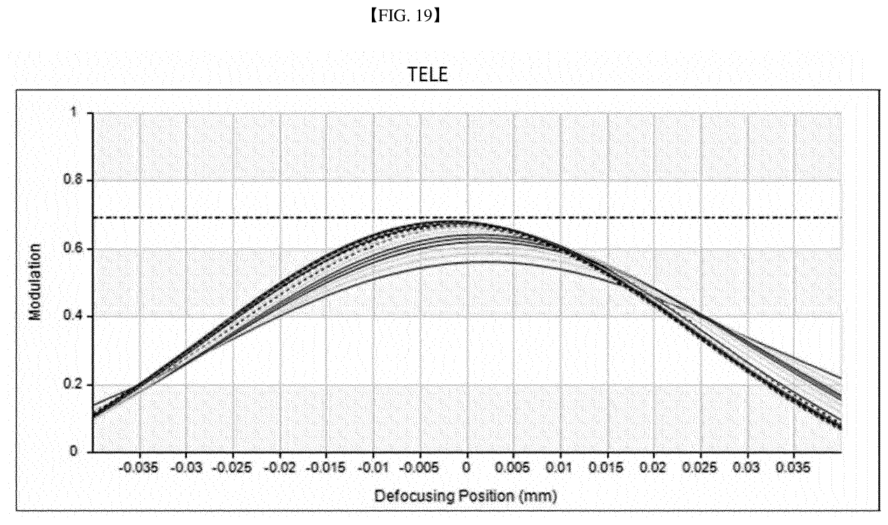

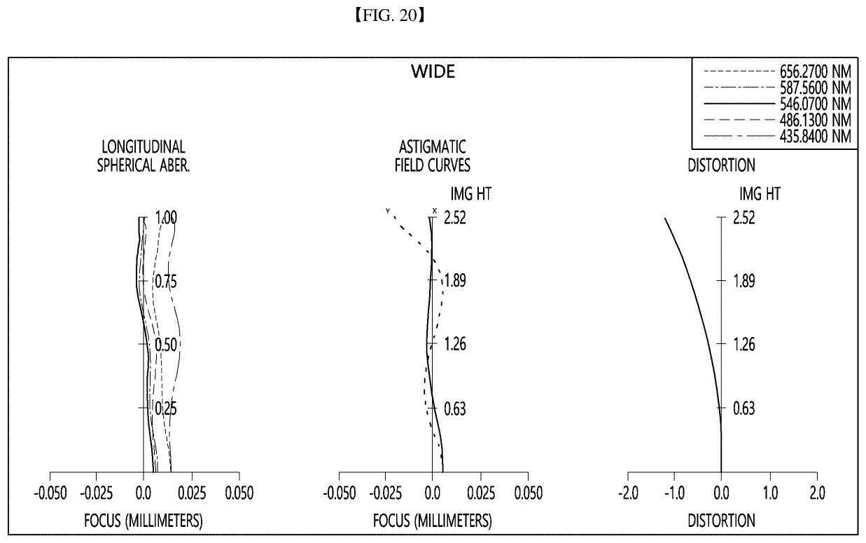

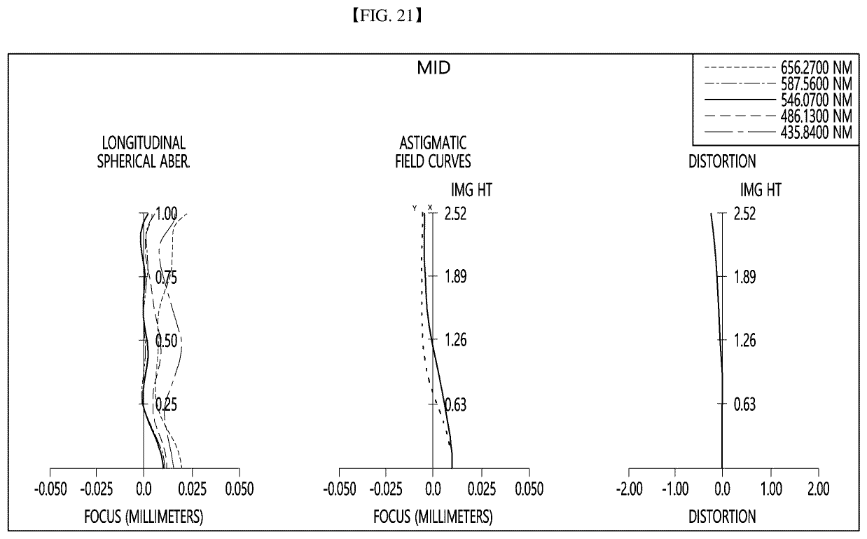

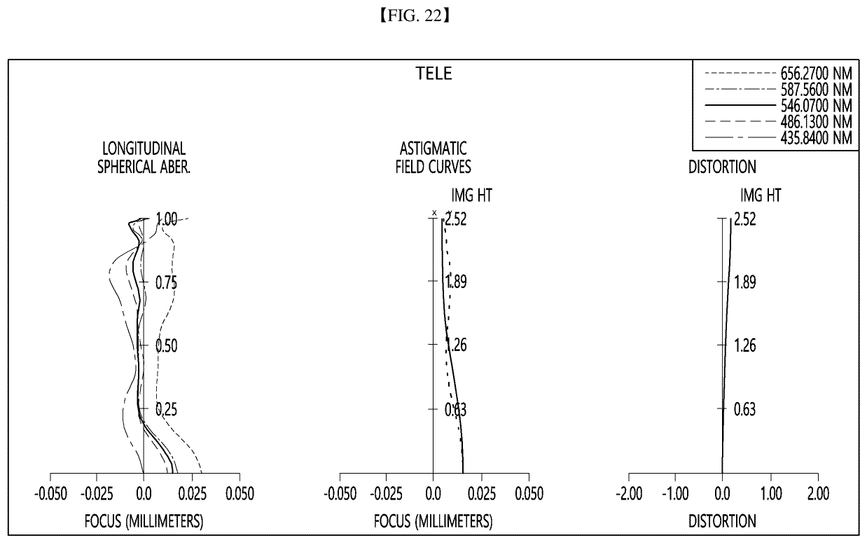

Referring to Table 6, the ratio CT/ET of the center thickness CT and the edge thickness ET of each lens of the lens unit 100A may be different from each other, and the CT/ET value of the fourth lens 114 may be the largest, and the CT/ET value of the eighth lens may be the smallest. The lenses having the CT/ET value less than 1 may be 5 or less, and may include the second, third, fifth, sixth, and eighth lenses, and the values having the CT/ET value greater than 2 may be 1, and may include the fourth lens. As shown in FIGS. 12 and 13, the Abbe number Vd4 of the fourth lens 114 included in the second lens group G2 may be 30 or higher or 40 or higher than the Abbe number Vd5 of the fifth lens 115. Since the fourth lens 114 and the fifth lens 115 have the above-described Abbe number difference, the chromatic aberration change that occurs when the magnification changes according to the movement M1 of the second lens group G2 may be minimized. As shown in FIG. 12 and FIG. 14, the Abbe number Vd8 of the eighth lens 118 included in the third lens group G3 may be 20 or more or 30 or more higher than the Abbe number Vd7 of the seventh lens 117. Since the seventh lens 117 and the eighth lens 118 have the above-described Abbe number difference, the chromatic aberration change that occurs when the magnification changes according to the movement M2 of the third lens group G3 may be minimized and/or compensated for, thereby performing an achromatic function.

The camera module according to the second embodiment can obtain information about a subject at various magnifications. In detail, the driving member can control the positions of the second lens group G2 and the third lens group G3, and thereby the camera module can operate at various magnifications. For example, referring to FIGS. 12, 17, and 20, the camera module including the optical system 1000 can operate in the first mode having a first magnification. The first magnification may be about 3 to about 5 times. In detail, in an embodiment, the first magnification may be about 3.5 times. In the first mode, each of the second lens group G2 and the third lens group G3 may be moved to a set position. Accordingly, each of the first to third lens groups G3 may be arranged at a set interval. For example, the second lens group G2 may be positioned in an area spaced apart from the first lens group G1 by a first interval DG12, and the third lens group G3 may be positioned in a region spaced apart from the second lens group G2 by a second interval DG23. Here, the first and second intervals DG12 and DG23 may mean intervals between the lens groups on the optical axis OA, and may vary depending on the operation mode.

When the camera module operates in the first mode, the optical system 1000 may have a TTL value and a BFL1 value at the first position. In addition, the optical system 1000 may have an M1F defined as a first effective focal length (EFL) at the first position. In addition, the FOV of the camera module in the first mode may be less than about 35 degrees, and the F-number may be less than about 3.

When the camera module operates in the second mode, the optical system 1000 may have a TTL value and a BFL2 value at the second position. In addition, the optical system 1000 may have an M2F defined as a second EFL at the second position. In addition, the FOV of the camera module in the second mode may be less than about 25 degrees, and the F-number may be less than about 3.4. When the camera module operates in the third mode, the optical system 1000 may have a TTL value and a BFL3 value at the third position. In addition, the optical system 1000 may have an M3F defined as a third EFL at the third position. In addition, the FOV of the camera module in the third mode may be less than about 20 degrees, and the F-number may be less than about 4.

As shown in FIG. 16, the relative illumination (RI) in each mode can change according to the height of the image sensor, and it may be seen that the relative illumination at the periphery or edge of the image sensor is 50% or more. The optical system 1000 may have excellent aberration characteristics as shown in FIGS. 17 and 20 in the first mode. In detail, FIG. 17 is a graph of diffraction MTF characteristics of the optical system 1000 operating in the first mode (first magnification), and FIG. 20 is a graph of aberration characteristics. The diffraction MTF characteristic graph is measured in units of about 0.252 mm over a spatial frequency range of 0.000 mm to 2.2520 mm. In the diffraction MTF graph, T represents the MTF change in spatial frequency per millimeter of a tangential circle, and R represents the MTF change in spatial frequency per millimeter of a radial circle. Here, MTF (Modulation Transfer Function) depends on the spatial frequency of cycles per millimeter.

In the aberration graph of FIG. 20, spherical aberration (Longitudinal Spherical Aberration), astigmatic field curves, and distortion are measured from left to right. In FIG. 17, the X-axis can represent the focal length (mm) and distortion (%), and the Y-axis can represent the height of the image. In addition, the graph for spherical aberration is a graph for light in the wavelength bands of about 435 nm, about 486 nm, about 546 nm, about 587 nm, and about 656 nm, and the graph for astigmatism and distortion is a graph for light in the wavelength band of 546 nm. In the aberration diagram of FIG. 20, the closer each curve is to the Y-axis, the better the aberration correction function may be interpreted. Referring to FIG. 20, it may be seen that the optical system 1000 according to the embodiment has measurement values close to the Y-axis in almost all areas.

Table 7 and FIG. 14 are about the items of the Equations described above in the optical system 1000 of the embodiment, including the TTL (mm), back focal length (BFL), effective focal length F (mm), ImgH (mm), effective diameter CA (mm), thickness (mm), TD (mm), which is the optical axis distance from the first surface S1 to the fourteenth surface S14, the focal lengths F1, F2, F3, F4, F5, F6, F7, and F8 (mm) of each of the first to seventh lenses, the sum of the refractive indices of each lens, the sum of the Abbe numbers of each lens, the sum of the center thicknesses (mm) of each lens, the sum of the center distances between adjacent lenses, the effective diameter, the diagonal FOV (Degree), the edge thickness ET, the focal lengths of the first and second lens groups, the F number, etc.

TABLE 7

| Items | Values | Items | Values |
|---|---|---|---|
| F1 | 21.61 | ET1 | 1.148 |
| F2 | −99.05 | ET2 | 1.404 |
| F3 | −8.175 | ET3 | 1.017 |
| F4 | 5.1405 | ET4 | 0.916 |
| F5 | −47.86 | ET5 | 1.950 |
| F6 | −7.395 | ET6 | 1.607 |
| F7 | 7.3326 | ET7 | 1.461 |
| F8 | −9.701 | ET8 | 1.046 |
| G1F | −15.89 | ΣIndex | 12.923 |
| G2F | 5.78 | ΣAbbe | 280.298 |
| G3F | −10.81 | ΣCT | 10.654 |

Table 8 shows the center distance between the first and second lens groups DG12 according to the first to third modes, the center distance between the second and third lens groups DG23, the center distance between the eighth lens and the optical filter DG4, the EFL according to each mode, the size of the EPD according to each mode, the optical axis distance (TD) of the lens according to each mode, the F number and field of view, and the BFL according to each mode.

TABLE 8

| Items | First mode | Second mode | Third mode |
|---|---|---|---|
| DG12 (mm) | 4.708 | 1.982 | 0.450 |
| DG23 (mm) | 1.876 | 1.074 | 1.234 |
| DG4 (mm) | 1.553 | 4.997 | 6.353 |
| EFL(M1F/M2F/M3F) | 9.9 | 15.60 | 19.80 |
| EPD(EPD1/EPD2/EPD3) | 4.3797 | 5.1156 | 5.6503 |
| TD(TD1/TD2/TD3) | 19.7724 | 16.2437 | 14.8724 |
| F-number | 2.741 | 3.050 | 3.504 |
| FOV (Degree) | 28.912 | 18.407 | 14.500 |
| BFL (BFL1/BFL2/BFL3) | 2.653 | 6.182 | 7.553 |

Tables 9 and 10 are results for the Equations 1 to 55 described above in the optical system 1000 of the second embodiment. In detail, it may be seen that the optical system 1000 according to the second embodiment satisfies all of the Equations 1 to 55. Accordingly, the optical system 1000 may have good optical performance and excellent optical characteristics at the center and periphery portions of the FOV.

TABLE 9

| Equations | | Values |
|---|---|---|
| 1 | n_G1, n_G2, n_G3 > 1 | satisfaction |
| 2 | 0.7 < CA41/CA11 < | 0.897 |
| | 1.2 | |
| 3 | 2 < CT1/CT3 < 5 | 3.000 |
| 4 | 0 < CT1/CT4 < 1 | 0.652 |
| 5 | 1.2 < ET3/CT3 < 3.2 | 2.033 |
| 6 | G1F < 0 | −15.890 |
| 7 | CRA < 20 | satisfaction |
| 8 | (TTL/DG1) > 3.5 | 5.143 |
| 9 | 2 < TTL/EPD3 < 7 | 3.969 |
| 10 | 2 < CT_Max/CT_ | 4.600 |
| | Min < 6 | |
| 11 | 1 < CA_Max/ | 1.327 |
| | CA_Min < 3 | |
| 12 | 0.1 < ΣCG_Wide/TTL < | 0.384 |
| | 0.6 | |
| 13 | 0.5 < DG1/DG2 < 3 | 1.045 |
| 14 | 0.5 < DG2/DG3 < 2 | 0.897 |
| 15 | 0 < CG2/TTL < 0.2 | 0.026 |
| 16 | 3 < TTL/DG2 < 10 | 5.373 |
| 17 | 20 < IVd4 − Vd5I < 70 | 57.587 |
| 18 | 15 < IVd8 − Vd7I < 60 | 36.466 |
| 19 | 1.6 < n1 | 1.669 |
| 20 | 1 < L1R1/L3R2 < 2.5 | 1.953 |
| 21 | 1.5 < L1R1/L4R1 < 3.5 | 2.491 |
| 22 | 0 < L3R2/L4R1 < 2 | 1.275 |
| 23 | 1 < L1R1/L8R2<3 | 1.993 |
| 24 | 0 < Mode12_mG2/TTL < | 0.122 |
| | 0.5 | |
| 25 | 0 < Mode23_mG2/TTL < | 0.036 |
| | 0.5 | |
| 26 | 0.3 < Mode12_ | 0.653 |
| | mG2/DG2 < 1 | |
| 27 | 0 < Mode23_mG3/DG3 < | 0.172 |
| | 0.5 | |
| 28 | 1 < (CT1/ET1)/ | 2.655 |
| | (CT3/ET3) < 5 | |
| 29 | 0.5 < (CT1/ET1)/ | 0.957 |
| | (CT7/ET7) < 1.5 | |
| 30 | 1 < Model(DG12/ | 2.509 |
| | DG23) < 5 | |

TABLE 10

| Equations | | Values |
|---|---|---|
| 31 | (<Mode3 (DG12 ) | 0.365 |
| | DG23) < 0.7 | |
| 32 | 0.5 < TD2/TTL < 1 | 0.724 |
| 33 | 1 < TD1/TD2 < 1.5 | 1.217 |
| 34 | 10 < TD3 < TD2 < | satisfaction |
| | TD1 < 20 | |
| 35 | 0.5 < BFL1/TTL < 1 | 0.276 |
| 36 | 2 < BFL3/BFL1 < 4 | 2.847 |
| 37 | 1.5 < TD3/BFL3 < 3 | 1.969 |
| 38 | 2 < Mode_CG_Max/ | 5.673 |
| | Mode_CG_Min < 8 | |
| 39 | 1 < BFL1 < 5 | 2.653 |
| 40 | 30 < Aver_Abbe < 50 | 35.037 |
| 41 | 1.5 < Aver_Index < 1.8 | 1.615 |
| 42 | 2 < \| G1F/G2F | 2.749 |
| | \| < 4 | |
| 43 | 1 < M2F/M1F < 10 | 1.576 |
| 44 | 2 < M2F/EPD2 < 7 | 3.049 |
| 45 | 0.1 < M1F/EPD1 < 3 | 2.260 |
| 46 | M1F < M2F < M3F | satisfaction |
| 47 | 0 < TTL/M2F < 2 | 1.438 |
| 48 | 0.1 < TTL/M1F < 5 | 2.265 |
| 49 | 1 < CA_Max/ImgH < 3 | 2.302 |
| 50 | 5 < TTL/ImgH < 12 | 8.899 |
| 51 | 1 <BFL2/ImgH < 3 | 2.453 |
| 52 | 2 < BFL3/ImgH < 4 | 2.997 |
| 53 | 1 < EPD1 < EPD2 < | satisfaction |
| | EPD3 < 7 | |
| 54 | 0 < Max_Distortion < 3 | 1.200 |
| 55 | 8 < FOV3 < FOV2 < | satisfaction |
| | FOV1 < 45 | |
| 44 | 2<M2F/EPD2 < 7 | 3.049 |

The optical system and camera module according to the first and second embodiments disclosed above can satisfy at least one or two or more of Equations 1 to 30 and/or Equations 31 to 55, or can satisfy all Equations.

FIG. 24 is a drawing illustrating a camera module according to an embodiment applied to a mobile terminal. Referring to FIG. 24, the mobile terminal 1 can include the camera module 10 disclosed in the embodiment on the rear side. As another example, the mobile terminal 1 can include the camera module disclosed in the embodiment on the front side. The camera module 10 can include an image capturing function. In addition, the camera module 10 can include at least one of an auto focus, a zoom function, and an OIS function.

The camera module 10 can process a still image or a video frame obtained by the image sensor 300 in a shooting mode or a video call mode. The processed image frame may be displayed on the display unit (not shown) of the mobile terminal 1 and stored in the memory (not shown). In addition, although not shown in the drawing, the camera module may be further arranged on the front of the mobile terminal 1. For example, the camera module 10 may include a first camera module 10A and a second camera module 10B. At this time, at least one of the first camera module 10A and the second camera module 10B may include the optical system 1000 described above. Accordingly, the camera module 10 may have a slim structure and may capture a subject at various magnifications.

The mobile terminal 1 may further include an autofocus device 31. The autofocus device 31 may include an autofocus function using a laser. The autofocus device 31 may be mainly used in conditions where the auto-focus function using the image of the camera module 10 is degraded, for example, in a close range of 10 m or less or in a dark environment. The autofocus device 31 can include a light-emitting unit including a vertical cavity surface-emitting laser (VCSEL) semiconductor element, and a light-receiving unit converting light energy into electric energy, such as a photodiode. The mobile terminal 1 can further include a flash module 33. The flash module 33 can include a light-emitting element that emits light inside. The flash module 33 can emit light in a visible light wavelength band. For example, the flash module 33 can emit white light or light of a color similar to white. However, the embodiment is not limited thereto, and the flash module 33 can emit light of various colors. The flash module 33 may be operated by the camera operation of the mobile terminal or the control of the user. The features, structures, effects, etc. described in the embodiments above are included in at least one embodiment of the present invention, and are not necessarily limited to one embodiment.

Features, structures, effects, etc. described in the embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

1. An optical system comprising:
a first to third lens group arranged along an optical axis from an object side to a sensor side and each including at least one lens,
wherein the first lens group and the third lens group have negative power,
wherein the second lens group has positive power,
wherein a position of the first lens group is fixed,
wherein the second lens group has a smaller number of lenses than a number of lenses of the first lens group,
wherein the second and third lens groups are movable in a direction of the optical axis,
wherein the third lens group includes a last lens closest to an image sensor among the lenses in the third lens group,
wherein the first to third lens groups has operation modes with different magnifications according to a movement of at least one of the second lens group and the third lens group,
wherein at least one of the second and third lens groups has a lens having a thickest center thickness among the lenses,
wherein an optical axis distance between a surface of the first lens group closest to the object side and an imaging surface of the image sensor is TTL,
wherein a size of an entrance pupil diameter of the optical system in the highest magnification of the operation mode is EPD3, and
wherein the following Equation satisfy: 2<TTL/EPD3<7.

2. The optical system of claim 1,
wherein an optical axis distance between the last lens closest to the image sensor and the image sensor varies depending on the operation mode,
wherein an optical axis distance between an object-side surface of a lens closest to the object in the first lens group and a sensor-side surface of the last lens closest to the image sensor varies depending on the operation mode.

3. The optical system of claim 1,
Wherein the operation mode includes a wide mode,
wherein the wide mode is Model,
wherein an optical axis distance between the first and second lens groups is DG12 and an optical axis distance between the second and third lens groups is DG23 in the wide mode,
wherein the following Equation satisfies: 1<Model (DG12/DG23)<5.

4. The optical system of claim 1,
wherein the operating mode includes a tele mode,
wherein the tele mode is Mode3,
wherein an optical axis distance between the first and second lens groups is DG12 and an optical axis distance between the second and third lens groups is DG23 in the tele mode,
wherein the following Equation satisfies: 0<Mode3 (DG12/DG23)<0.7.

5. The optical system of of claim 1,
wherein a maximum distance between adjacent lenses depending on the operating mode is Mode_CG_Max,
wherein a minimum distance between adjacent lenses according to the operating mode is Mode_CG_Min,
wherein the following Equation satisfies: 2<Mode_CG_Max/Mode_CG_Min<8.

6. The optical system of claim 1,
wherein a number of lenses of the first lens group is 3,
wherein a number of lenses of the third lens group is 2 or 3,
wherein an absolute value of focal lengths of the first and third lens groups is greater than a focal length of the second lens group.

7. The optical system of claim 6,
wherein the optical system includes a wide mode having a first effective focal length EFL1, a middle mode having a second effective focal length EFL2, and a tele mode having a third effective focal length EFL3,
wherein the following Equation satisfies: EFL1<ELF2<EFL3.

8. The optical system of claim 7,
wherein a field of view in the wide mode is FOV1, a field of view in the middle mode is FOV2, and a field of view in the tele mode is FOV3, and
wherein the following Equation satisfies: 8 degrees<FOV3<FOV2<FOV1<45 degrees.

9. The optical system of claim 1,
wherein the second lens group includes an object-side lens having an aspherical surface made of glass and having a biconvex shape, and a sensor-side lens having an aspherical surface made of plastic on a sensor side of the object-side lens.

10. An optical system comprising:
a first lens group having first to third lenses;
a second lens group having fourth and fifth lenses; and
a third lens group having at least two lenses,
wherein the first lens group, the second lens group, and the third lens group are arranged in a direction of the optical axis from an object side toward a sensor side,
wherein the first lens has positive refractive power and has a convex shape on the object side,
wherein the third lens has negative refractive power and has a concave shape on both sides,
wherein the fourth lens has positive refractive power and has a convex shape on both sides,
wherein a last lens closest to an image sensor the lenses in the third lens group has negative refractive power,
wherein the second lens group and the third lens group move in the direction of the optical axis, and
wherein an optical axis distance between the last lens and the image sensor varies depending on an operation mode.

11. The optical system of claim 10,
wherein the first lens group has negative refractive power,
wherein the first lens has a meniscus shape convex toward the object side,
wherein the second lens has a meniscus shape convex toward the sensor side,
wherein the second and fifth lenses have negative refractive power.

12. The optical system of claim 10,
wherein the fourth lens and the last lens have refractive indices less than 1.6,
wherein the fourth lens is made of glass, and the lenses other than the fourth lens are made of plastic.

13. The optical system of claim 10,
wherein the first lens has different maximum lengths in a first direction perpendicular to the optical axis and maximum lengths in a second direction perpendicular to the optical axis,
wherein the maximum lengths of the first lens in the first and second directions are the largest among the lenses,
wherein a difference between a center thickness and an edge thickness of the fifth lens is 0.9 or more, and
wherein a difference between a center thickness and an edge thickness of the sixth lens is 0.9 or more.

14. The optical system of claim 10,
wherein an optical axis distance between the first and second lens groups and an optical axis distance between the second and third lens groups is at least 0.2 mm or more and at most 8 mm or less,
wherein an optical axis distance from a center of an object-side surface of the fourth lens to a center of a sensor-side surface of the fifth lens is DG2,
wherein an optical axis distance from an object-side surface of the first lens to an imaging surface of the image sensor is TTL,
wherein the following Equation satisfies: 3<TTL/DG2<10.

15. A camera module comprising an optical system and a driving member,
wherein the optical system includes an optical system according to claim 1,
wherein the driving member moves at least one of the second and third lens groups in a direction of the optical axis according to an operation mode of the optical system.

16. The optical system of claim 6,
wherein the first lens group includes first to third lenses aligned along the optical axis from the object toward the sensor side,
wherein the first lens has a convex meniscus shape toward the object side,
wherein the second lens has a convex meniscus shape toward the sensor side.

17. The optical system of claim 16,
wherein the second lens has negative refractive power.

18. The optical system of claim 16,
wherein the second lens group includes fourth and fifth lenses aligned along the optical axis from the object toward the sensor side,
wherein the fifth lens has negative refractive power,
wherein the fifth lens has a convex meniscus shape toward the sensor side.

19. The optical system of claim 16,
wherein the last lens has a convex meniscus shape toward the object.

20. The optical system of claim 19,
wherein a power of the last lens has a negative value.
